(19) United States
(12) Patent Application Publication
(10) Pub. No.: US 2026/0171054 A1
(43) Pub. Date: Jun. 18, 2026

(54) RAPID FINE-TUNED ARTIFICIAL INTELLIGENCE MUSIC GENERATION USING SEED DATA

(71) Applicant: SourceAudio Holdings, LLC, Redondo Beach, CA (US)

(72) Inventor: Brent Phillips, Glendale, CA (US)

(21) Appl. No.: 19/419,689

(22) Filed: Dec. 15, 2025

Related U.S. Application Data
(60) Provisional application No. 63/734,536, filed on Dec. 16, 2024.

(51) Int. Cl. G10H 1/00

(52) U.S. Cl. CPC G10H 1/0025; G10H 2250/311

(57) ABSTRACT

A set of music tracks associated with a user request is identified. The set of music tracks and a prompt associated with the user request are processed to generate a musical composition of a new content item. One or more musical instruments used to perform the set of music tracks are identified based on analysis of the set of music tracks. An audio version of the musical composition of the new content item is generated based on the one or more musical instruments.

### RELATED APPLICATION

This application claims priority under 35 U.S.C. § 119(e) to U.S. Provisional Application No. 63/734,536, titled “Rapid Fine-Tuned Artificial Intelligence Music Generation Using Seed Data,” filed on Dec. 16, 2024, the entire content of which is incorporated herein by reference.

### TECHNICAL FIELD

This disclosure relates to the field of generative artificial intelligence (AI), and in particular to rapid fine-tuned AI music generation using seed data.

### BACKGROUND

The emergence of generative artificial intelligence (AI) models has revolutionized the way in which users create and interact with digital content. Generative AI models are trained on a large data set of existing digital content, but it can be difficult to identify which digital content items, from the training data set, influenced the newly generated content items. The identification of which digital content item(s) influenced the generation of the AI-generated content items can have a direct impact on the generated content item's validity, authenticity, and/or royalties.

### BRIEF DESCRIPTION OF THE DRAWINGS

The present disclosure will be understood more fully from the detailed description given below and from the accompanying drawings of various embodiments of the present disclosure, which, however, should not be taken to limit the present disclosure to the specific embodiments, but are for explanation and understanding only.

FIG. 1 is a block diagram illustrating a system architecture, according to some embodiments of the present disclosure.

FIG. 2 is a block diagram illustrating an audio generation system, according to some embodiments of the present disclosure.

FIG. 3 is a block diagram illustrating a workflow for generating a new audio content item using a generative AI model that is rapid fine-tuned on a set of seed tracks, according to some embodiments of the present disclosure.

FIG. 4 is a flow diagram illustrating an example method for generating a new audio content item using one or more rapid fine-tuned generative AI models, according to some embodiments of the present disclosure.

FIG. 5 illustrates is a block diagram illustrating an exemplary computer system, according to some embodiments of the present disclosure.

### DETAILED DESCRIPTION

Embodiments are described for rapid fine-tuned AI music generation using seed data, with attribution. Generative artificial intelligence (AI) models can create a variety of types content, such as text, images, and/or audio. For example, a generative AI model can be trained to generate new music by leveraging deep learning techniques to compose new music by learning from vast amounts of musical data. A generative AI model can be trained to learn patterns in music, such as harmony, melody, and song structure, and can use the identified patterns to create an original composition. Such a generative AI model can be trained on a large dataset of musical data that can include music of various genres, styles, and forms. The training dataset can include thousands or millions of tracks. When a generative AI model generates a new musical composition, the model draws upon its entire training dataset to varying degrees. As such, it can be difficult or impossible to identify which tracks from the training dataset influenced the generation of the newly created musical composition. This lack of traceability creates significant challenges for attribution and royalty allocation. Without knowing which tracks influenced the generated output, it becomes difficult or impossible to attribute the appropriate rights and royalties to the creators of the original tracks that contributed to the newly created musical composition. This problem may affect the validity and authenticity of AI-generated content and may prevent proper compensation of original artists whose words were used in the generation process.

Aspects of the present disclosure address the above-noted and other deficiencies by providing a music generation component that performs rapid fine-tuning of a generative AI model using a manageable number of seed tracks. The output generated by an AI model that is fine-tuned on the seed tracks is heavily influenced by the seed tracks, and thus the generated output may be properly attributed to the seed tracks. As used herein, a user request refers to an initial input or indication provided by a user to the music component that initiates the music generation process. As used herein, a prompt refers to an instruction or query that is provided to the generative AI model, which may be derived from or associated with the user request. In some embodiments, the prompt may include the user request itself (such that the user request is provided directly to the generative AI model), musical variables identified from the user request, and/or the seed tracks.

In some embodiments, the music generation component may identify a set of seed tracks from the user request received from a user. In one embodiment, the user request may identify the set of seed tracks (e.g., by providing the titles and artists of the tracks, by indicating a particular album as the seed tracks, and so on). In one embodiment, the music generation component may identify, from the received user request, certain musical variables, such as song structure, genre of music, beats per minute (BPM), note density, chord progression, key, musical style, etc. The music generation component may search a set of data for seed tracks that match the identified musical variables. The set of data may be the training dataset used to train the generative AI model.

In some embodiments, the music generation component may use the identified seed tracks to rapid fine-tune the trained generative AI model. Rapid fine-tuning refers to adapting a pre-trained generative AI model to new data or tasks through a condensed optimization process that updates a subset of its parameters or layers. In one embodiment, the music generation component may rapid fine-tune the generative AI model by adjusting the parameters (e.g., heavily weighting certain parameters) of the trained generative AI model to use the seed tracks in generating new content items while maintaining the trained generative AI model's global knowledge of the training dataset. In one embodiment, the music generation component may perform rapid fine-tuning of the generative AI model by providing the set of seed tracks, optionally along with a prompt associated with the user request, in the context window of the generative AI model. As used herein, a context window refers to the portion of input data that a generative AI model can reference when generating output, such that data provided within the context window influences the model's generation.

In some embodiments, the music generation component may query the rapid fine-tuned generative AI model by providing a prompt aligned with the user request. In one embodiment, the prompt may be the user request. In one embodiment, the music generation component may generate a prompt that includes or implies the musical variables identified from the user request. The music generation component may identify certain musical variables from the user request, including, for example, song structure, genre of music, BPM, chord progression, key, musical style, melody, harmony, rhythm, timing, timbre, note density, etc. In some embodiments, the music generation component may automatically generate the prompt by extracting and formatting musical variables from the user request into an instruction suitable for the generative AI model. The music generation component may generate a prompt that includes or implies the musical variables along with an instruction to generate new music based on the musical variables. The music generation component may optionally include the seed tracks in the prompt.

In some embodiments, the music generation component may provide the prompt as input to the trained rapid fine-tuned generative AI model. In some embodiments, the music generation component may provide the prompt as input to multiple rapid fine-tuned generative AI models. Each of the multiple generative AI models may be used to generate a portion of a content item, such as a chorus, a verse, an intro, an outro, etc. The music generation component may provide the prompt to each AI model, may provide a portion of the prompt to one or more AI models, and/or may generate one or more sub-prompts based on the prompt and provide the one or more sub-prompts to one or more AI models. For example, the music generation component may generate a separate prompt or sub-prompt for each AI model. Each separate prompt or sub-prompt may be tailored for the particular AI model. A sub-prompt can refer to a derivative instruction that is generated from the main prompt and tailored for a particular AI model and the specific section that the AI model is responsible for generating, in embodiments. As an illustrative example, the user request may be “I want an upbeat workout song for running on the beach,” and the music generation component may generate a main prompt such as “generate an upbeat workout song with high energy, a tempo between 120-140 BPM, major key tonality, driving rhythm, and instrumentation suitable for a beach setting. The music generation component may further generate sub-prompts for each AI model, such as “generate an energetic intro with building intensity for a beach workout song” for an intro-generating AI model, “generate a verse with moderate energy and rhythmic drive for a beach running song” for a verse-generating AI model, and “generate an upbeat, high-energy chorus for a beach workout song” for a chorus-generating AI model.

In some embodiments, the output of the rapid fine-tuned generative AI model(s) may be heavily influenced by the seed tracks. The music generation component may receive, as output from the AI model(s), a composition of a new song. In embodiments in which multiple AI models are used, the music generation component may combine the outputs of the multiple models to generate a composition of a new song or track. In some embodiments, the output of the AI model(s) may be a content item (e.g., a musical content item such as audio that includes a recording of a synthetic performance of the composition).

In some embodiments, the music generation component may identify instrument data from the seed tracks. The music generation component may identify the instruments used in each seed track. In some embodiments, the instrument data of the seed tracks may be determined during the preprocessing of the training dataset. In some embodiments, the music generation component may isolate portions of each seed track by instrument, e.g., using stem separation techniques. The music generation component may compare the identified instruments from each seed track to a database of existing instrument data. For example, the music generation component may generate a vector representation of each isolated instrument portion using a pre-trained audio neural network and compare the vector representation to vector representations of virtual instruments to identify the instruments used in the seed tracks. The music generation component may identify a number of instruments from the existing instrument data that most closely resemble the instruments used in the seed tracks. The music generation component may use the identified instruments when rendering the new content item to audio. That is, in some embodiments, the music generation component may render the composition of the content item using the identified instrument data. The music generation component may provide the rendered composition (e.g., recording of a synthetic performance of the composition) to a user device. In some embodiments, the music generation component may enable a user to make modifications to the rendered composition, e.g., by changing one (or more) notes of the composition, by changing the instruments used in the rendered composition, by changing the genre of the rendered composition, etc.

In some embodiments, the music generation component may generate derivatives of a specific song, collection of songs (e.g., album), and/or artist. Rather than identifying the set of seed tracks from a user request, the music generation component may receive an indication of a song, collection of songs, and/or artist from a user, and may identify seed tracks based on the indication. The music generation component may then generate new content items that are derivatives of the song, collection of songs, and/or artist indicated in the user request.

In some embodiments, the music generation component may implement genre swapping of a particular song. The music generation component may receive or identify a particular track, and may receive or identify a request to change the genre of the particular track to a specified target genre. Such a request may be included in the user input, and/or in a provided prompt, in embodiments. The music generation component may identify the structural data of the track, including, for example, the song structure data, the chord progression, and/or the key. The music generation component may identify seed tracks (e.g., from the training dataset) that match the target genre. The music generation component may perform rapid fine-tuning of the trained generative AI model using the identified seed tracks that match the target genre, and may use the rapid fined-tuned AI model to generate a version of the particular song in the style of the target genre.

In some embodiments, the music generation component may determine an attribution breakdown for the new content item based on the set of tracks used to fine-tune to the AI model. The attribution breakdown may reflect a collection of rights for the newly generated track (e.g., composition rights, performance rights, lyrics rights, etc.). In some embodiments, the attribution breakdown may mirror the rights of the seed tracks. That is, the collection of rights may be evenly divided among each of the seed tracks. In some embodiments, the attribution breakdown may include a certain percentage (e.g., 25%) attributed to the user who provided the user request on which the prompt is based, a certain percentage (e.g., 25%) attributed to the organization maintaining the AI model that generated the new track (e.g., as an administrative fee), and a remaining percentage (e.g., 50%) evenly divided among the rights holders of the seed tracks. The music generation component may provide the attribution breakdown to a user device, along with the generated new content item.

Aspects of the present disclosure present technical advantages including, but not limited to, providing validity and/or authenticity to content items generated by an AI model through deterministic attribution. By rapid fine-tuning a generative AI model based on a manageable number of seed tracks (e.g., five to ten tracks), aspects of the present disclosure eliminate the need for computationally expensive post-generation analysis that would otherwise be required to identify which tracks from a training dataset of thousands or millions of tracks influenced the generated output. Rather than attempting to perform resource-intensive similarity searches or audio fingerprinting operations on the entire training dataset after content generation, aspects of the present disclosure preemptively constrain the generative process to heavily weight (e.g., by up to approximately 80%) the influence of the identified seed tracks. This approach reduces computational overhead by avoiding the need to analyze and compare the generated content against the entire training dataset, thereby improving processing efficiency and reducing memory requirements. Aspects of the present disclosure further enable proper attribution and/or royalty allocation to be determined through a statistical breakdown, rather than requiring complex algorithmic analysis to reverse-engineer which training data influenced the generation of the new content items. Thus, the proper credit and/or royalties may be attributed to the creators of the content items that influenced the generation of the newly created content item in an efficient and low-computing resource intensive manner. Additionally, the preprocessing and tagging of the training dataset with musical information enables efficient natural language search functionality that quickly identifies relevant seed tracks without requiring real-time music information retrieval operations during the generation process, further reducing computational latency and resource consumption.

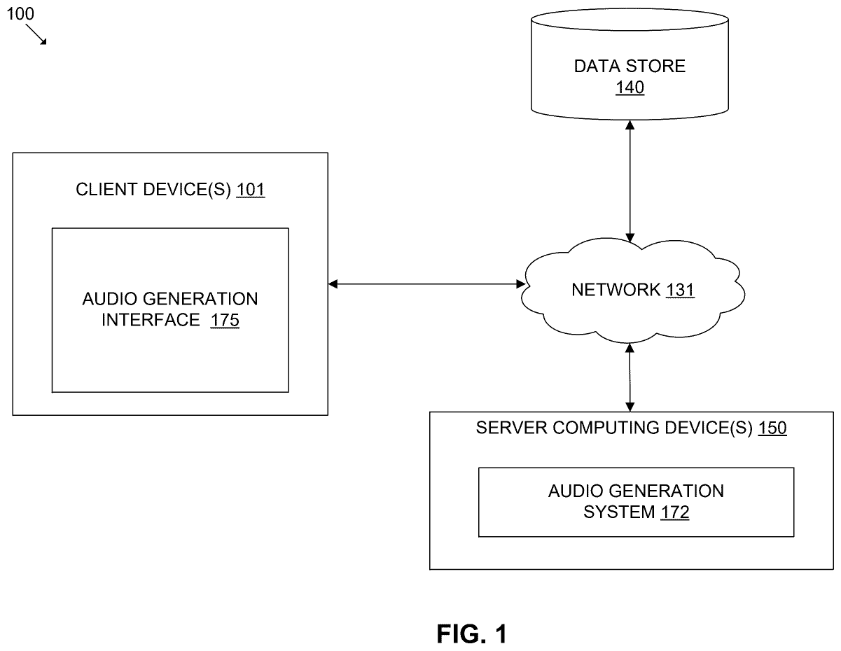

FIG. 1 is a block diagram illustrating an example system architecture 100, in which embodiments of the present disclosure may operate. In one embodiment, network environment 100 includes one or more computing devices (e.g., one or more client device(s) 101 and/or server computing device(s) 150) connected via network 131. Any number of client device(s) 101 may communicate with each other and/or with server computing device 150 through network 131. In some embodiments, the system 100 can include a data store 140 connected to the client device(s) 101 and/or the server computing device(s) 150 via network 131. The network 131 may include a local area network (LAN), a wireless network, a telephone network, a mobile communications network, a wide area network (WAN) (e.g., such as the Internet), a combination thereof, and/or similar communication system. The network 131 may include any number of networking and computing devices, such as wired and/or wireless devices. The network 131 may include a wireless infrastructure, which may be provided by one or more wireless communications systems, such as Wi-Fi hotspot connected with the network 131 and/or a wireless carrier system that can be implemented using various data processing equipment, communication towers, etc. Additionally or alternatively, the network 131 may include a wired infrastructure (e.g., Ethernet). In some embodiments, the network 131 can be a single network.

In some embodiments, data store 140 can be a persistent storage that is capable of audio data used in the generation of audio, e.g., by the audio generation system 172. For example, data store 140 may store generated audio data, instrument data, attribution data, seed data, and/or training dataset(s) used to the fine-tune one or more AI models. In some embodiments, data store 140 may be hosted by one or more storage devices, such as main memory, magnetic or optical storage based disks, tapes or hard drives, NAS, SAN, and so forth. In some implementations, data store 140 may be a network-attached file server, while in other embodiments data store 140 may be some other type of persistent storage such as an object-oriented database, a relational database, and so forth, that may be hosted by server computing device(s) 150, and/or client device(s) 101. In some embodiments, data store 140 may be hosted by or one or more different machines coupled to the server computing device(s) 150, and/or client device(s) 101, either directly and/or via network 131.

In some embodiments, the client device(s) 101 and/or server computing device(s) 150 may include one or more physical machines and/or virtual machines hosted by physical machines. The physical machines may include rackmount servers, desktop computers, and/or other computing devices. In one embodiment, the client device(s) 101 and/or server computing device(s) 150 include a virtual machine managed and provided by a cloud service provider system. Each virtual machine offered by a cloud service provider may be hosted on a physical machine configured as part of a cloud. Such physical machines are often located in a data center. A cloud provider system and cloud may be provided as an infrastructure as a service (IaaS) layer.

In some embodiments, computing device(s) 101 and/or 150 may each include local storage (not shown) for storing an operating system (OS), program, and/or specialized applications to be run on the computing device. Computing devices 101 and/or 150 may further include storage for storing media content items, such as audio data, which may include new audio generated by the audio generation system 172. The audio tracks may be, for example, music (e.g., songs, tracks, compositions, etc.), an audio book (or a portion of an audio book), a voice or audio recording, a news or radio broadcast, recorded sound effects, a podcast, and/or any other type of audio data. The media content items may also be stored in attached or remote storage, such as in a storage area network (SAN), a network attached storage (NAS), or a cloud storage platform (e.g., storage as a service provided by a cloud service platform). In an example, computing device 101 and/or 150 is connected to data store 140, which stores information on audio data.

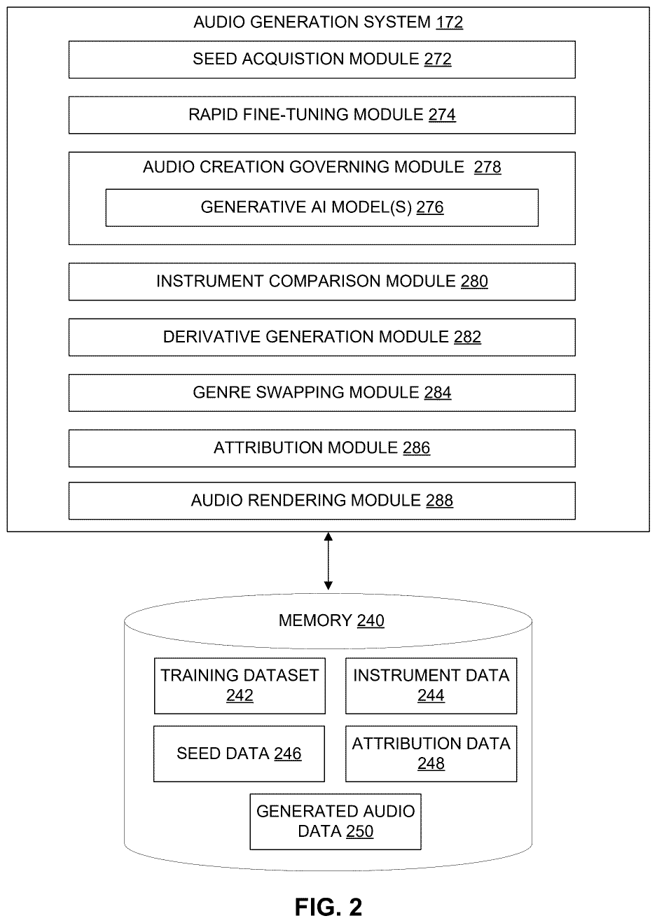

In some embodiments, the client device 101 may include an audio generation interface 175. In some embodiments, the audio generation interface 175 may be a software program hosted by a device (e.g., client device 101). In some embodiments, the audio generation interface 175 may include software instructions executed by a processor of the client device 101 to render graphical user interface elements on a display and receive user inputs through input devices such as a keyboard, mouse, or touchscreen. In some embodiments, the audio generation interface 175 may include software, hardware, and/or firmware configured to perform one or more operations to render graphical user interface elements on a display and receive user inputs. In some embodiments, the audio generation interface 175 may be implemented as a web-based application accessible through a web browser on the client device 101. The web browser may communicate with the audio generation system 172 hosted on the server computing device 150 via the network 131. In some embodiments, the audio generation interface 175 may access an audio generation system 172 executed on a server computing device, such as server computing device 150. The audio generation system 172 may implement a generative AI model, that is rapid fine-tuned using seed tracks, to generate new content in response to a user request received from client device 101. In some embodiments, the client device 101 may include an audio generation system 172 (or a portion thereof) executable directly on the client device 101. The audio generation system 172 is further described with respect to FIG. 2.

In some embodiments, the audio generation system 172 may be a software program hosted by a device (e.g., server computing device 150). In some embodiments, the audio generation interface 175 may include software instructions executed by a processor of the server computing device 150 to perform seed track identification, rapid fine-tuning of generative AI models, composition generation, instrument comparison, and/or audio rendering operations. In some embodiments, the audio generation system 172 may include software, hardware, and/or firmware configured to perform one or more operations with respect to perform seed track identification, rapid fine-tuning of generative AI models, composition generation, instrument comparison, and/or audio rendering operations.

In some embodiments, the audio generation system 172 may implement a workflow that identifies seed tracks from a training dataset based on user input, rapid fine-tunes one or more generative AI models using the identified seed tracks, and generates new musical compositions that are heavily influenced by the seed tracks. The audio generation system 172 may enable deterministic attribution of the generated musical compositions to the seed tracks that influenced their creation, thereby facilitating proper allocation of rights and royalties to the creators of the seed tracks. By constraining the generative process to a manageable number of seed tracks, the audio generation system 172 may provide transparency and traceability in AI-generated music creation.

In some embodiments, the seed tracks are not limited to tracks present in the training dataset used to train the generative AI model(s). For example, the audio generation system 172 may employ a retrieval-augmented generation (RAG) architecture in which the generative AI model(s) have access to an external database containing embeddings of tracks that were not included in the training of the generative AI model(s). In some embodiments, when a user provides a seed track or a user request, the audio generation system 172 may generate and/or retrieve an embedding for the seed track and/or for tracks relevant to the user request. The audio generation system 172 may query the external database to identify additional tracks that are similar to the provided seed track(s) and/or tracks relevant to the user request that can be used for the rapid-fine tuning process, even if the additional tracks were not part of the original training dataset. The identified tracks may be preprocessed using music information retrieval operations to extract the necessary musical information, and may then be used as seed tracks for the rapid fine-tuning process. This approach may enable the audio generation system 172 to generate new musical compositions influenced by tracks that were not available or not used during the initial training of the generative AI model(s).

In some embodiments, the audio generation system 172 may further identify virtual instruments that match the sonic characteristics of instruments used in the seed tracks and render the generated compositions into audio format using the identified virtual instruments. The audio generation system 172 may support various generation modes including derivative generation, genre swapping, and/or user-directed composition modification. The components and operations of the audio generation system 172 are described in greater detail throughout this specification, including with reference to FIG. 2 through FIG. 4.

In some embodiments, the audio generation interface 175 may provide user access to the audio generation system 172, whether the audio generation system 172 is executed locally on the client device 101 or remotely on server computing device 150. The audio generation interface 175 may include graphical user interface elements that enable a user to input a user request (e.g., a natural language prompts), select seed tracks, specify musical parameters, and/or receive generated audio compositions. In some embodiments, the audio generation interface 175 may present dropdown menus, text input fields, audio playback controls, and/or visualization elements that allow a user to interact with the generation process. In some embodiments, the audio generation interface 175 may enable a user to modify generated compositions by changing individual notes, swapping instruments, and/or regenerating specific sections of a composition. In some embodiments, the audio generation interface 175 may display attribution breakdowns showing the seed tracks that influenced the generated content and the corresponding royalty allocations.

In some embodiments, the audio generation interface 175 may present a note editing interface that displays the compositional data in a visual format, such as a piano roll or sheet music representation. The note editing interface may enable a user to select individual notes and modify their pitch, duration, timing, and/or velocity. The audio generation interface 175 may receive user input through the note editing interface indicating modifications to one or more notes, and may transmit the modifications to the audio creation governing module 278 for processing.

In some embodiments, the audio generation interface 175 may present an instrument selection interface that displays the instrument(s) currently assigned to each part of the composition. The instrument selection interface may include a dropdown menu, list view, and/or browsable library of available virtual instruments from the instrument data 244. The user may select an instrument part within the composition and choose a replacement virtual instrument from the instrument selection interface. The audio generation interface 175 may transmit the instrument selection to the audio rendering module 288 for re-rendering the composition with the selected virtual instrument.

In some embodiments, the audio generation interface 175 may present a genre selection interface that enables a user to specify a target genre for transforming the rendered composition or an existing track. The genre selection interface may include a dropdown menu listing available genres, a searchable genre browser, and/or genre category filters. Upon selection of a target genre, the audio generation interface 175 may transmit the genre selection to the genre swapping module 284 to initiate the genre transformation process.

FIG. 2 is a block diagram of an example audio generation system 172, in accordance with some embodiments of the present disclosure. In general, audio generation system 172 corresponds to audio generation system 172 of FIG. 1. In some embodiments, audio generation system 172 includes a seed acquisition module 272, a rapid fine-tuning module 274, a generative AI model(s) 276, an audio creation governing module 278, an instrument comparison module 280, a derivative generation module 282, a genre swapping module 284, an attribution module 286, and/or an audio rendering module 288. Alternatively, one or more logics and/or modules of the audio generation system 172 may be distinct modules or logics that are not components of audio generation system 172. Additionally, or alternatively, one or more of the modules or logics may be divided into further modules or logics and/or combined into fewer modules and/or logics. In some embodiments, each of the modules 272, 274, 278, 280, 282, 284, 286, and/or 288 may include software, hardware, firmware, or a combination thereof, and may comprise executable instructions, logic circuits, or processing components configured to perform specific functions within the audio generation system 172.

In some embodiments, audio generation system 172 may be connected to (e.g., may access) memory 240, which may store training dataset 242, instrument data 244, seed data 246, attribution data 248, and/or generated audio data 250.

In some embodiments, training dataset 242 may be used to train one or more generative AI model(s) 276. The training dataset may include thousands or millions of tracks, songs, compositions, and/or other audio data. In some embodiments, the training dataset 242 may include music tracks of different types such as songs, instrumental tracks, and/or compositions. The tracks may additionally include audio books or portions thereof, voice or audio recordings, news or radio broadcasts, recorded sound effects, podcasts, and/or any other type of audio data suitable for training generative AI models.

In some embodiments, the training dataset 242 may be preprocessed to identify and/or extract music information of the tracks (e.g., music tracks) in the training dataset. The preprocessing may involve performing music information retrieval operations on each track to extract musical qualities and characteristics. In some embodiments, the music information retrieval operations may analyze audio data from each track to extract the equivalent of sheet music, including the identification of individual musical notes and their positions within each track. The extracted music information may include, but is not limited to, such as key, chords, chord progressions, instrument choice, genre, style, musical notes, note density, beats per minute (BPM), song structure, melody, harmony, rhythm, timing, timbre, mood, and/or other musical attributes. Each track in the training dataset 242 may be tagged with the extracted musical information to enable efficient searching and/or retrieval. In some embodiments, the training dataset 242 may include thousands or tens of thousands of tags or labels associated with each track. The tags may be organized into categories such as genre, key, moods, styles, beats per minute, note density, chord progressions, and/or song structure, in embodiments. The preprocessed and tagged training dataset 242 may enable natural language searching to identify seed tracks that match specific musical criteria or user requests by translating natural language requests into musical elements through the tagged songs.

In some embodiments, instrument data 244 may be or include a library of digital instrument sounds that may be used to render compositions to audio. In some embodiments, the instrument data 244 may include a collection of virtual instruments that produce digital audio representations of various musical instruments. In some embodiments, the instrument data 244 may include multiple variations of the same instrument type, such as different piano models (e.g., Steinway grand piano, upright piano), different guitar types (e.g., steel guitar, nylon guitar, acoustic guitar, electric guitar), various wind instruments (e.g., different flute models, saxophones), and/or percussion instruments. In some embodiments, the digital audio representations may include digitized waveform data encoding the acoustic characteristics of each instrument, including parameters such as frequency content, amplitude envelope, harmonic structure, and/or timbral characteristics unique to each instrument type. In some embodiments, the digital audio representations may include sampled audio data captured from recordings of actual musical instruments, synthesized waveforms generated through digital signal processing techniques, or a combination thereof. Each virtual instrument in the instrument data 244 may be associated with a vector representation generated using a pre-trained audio neural network, such as a pre-trained audio neural networks (PANNs) model. The vector representations may enable comparison between the virtual instruments and instrument sounds extracted from seed tracks to identify the closest matching virtual instruments. The instrument data 244 may be stored as a separate dataset and database from the training dataset 242. In some embodiments, instrument data 244 may be accessed during the audio rendering process to convert compositional data into audible music using the selected virtual instruments.

In some embodiments, seed data 246 may include a subset of tracks identified from the training dataset 242 and/or provided by a user that are used to rapid fine-tune the generative AI model(s) 276. The seed data 246 may include a manageable number of tracks, such as five to ten tracks, that are selected based on their relevance to a user request or their similarity to a specified song, album, and/or artist. In some embodiments, the seed data 246 may include the preprocessed musical information associated with each seed track, such as the extracted sheet music equivalent (musical notes and positions), key, chord progressions, instrument choice, genre, note density, beats per minute, song structure, melody, harmony, rhythm, timing, timbre, and so on. The seed data 246 may also include rights information associated with each seed track, such as copyright ownership and/or royalty allocation data, such as for composition, lyrics, performance, and so on. The rights information may be used to determine the attribution breakdown for newly generated content items. In some embodiments, the seed data 246 may include tracks that are part of the training dataset 242, and/or may include tracks that were not used in the original training of the generative AI model(s) 276 but have been preprocessed using music information retrieval operations to extract the necessary musical information.

In some embodiments, attribution data 248 may include information that specifies the allocation of rights and/or royalties for newly generated content items based on the seed tracks used in the generation process. In some embodiments, the attribution data 248 may include copyright ownership information, royalty percentage allocations, rights holder identification data, and/or licensing terms associated with each seed track. In some embodiments, the attribution data 248 may include a statistical breakdown that distributes rights among the seed track rights holders, the user who provided the user request, and/or the organization maintaining the generative AI model. The attribution data 248 may specify, for example, that a first percentage of rights (e.g., 25%) is allocated to the user who provided the user request, a second percentage (e.g., 25%) is allocated to the organization maintaining the AI model as an administrative fee, and the remaining percentage (e.g., 50%) is divided among the seed tracks based on their contribution to the generation. In some embodiments, the attribution data 248 may include master rights and publishing rights information separately, enabling proper allocation of both types of rights to the appropriate rights holders. In some embodiments, the attribution data 248 may be generated by the attribution module 286 and stored for association with the corresponding generated content item in generated audio data 250.

In some embodiments, generated audio data 250 may include newly created audio content items produced by the audio generation system 172. The generated audio data 250 may comprise complete compositions in various formats, including compositional data representing musical notes and positions (similar to sheet music), rendered audio files in digital audio formats, or both. In some embodiments, the generated audio data 250 may include metadata associated with each generated content item, such as the seed tracks used in the generation process, the user request that initiated the generation, the identified instruments, song structure information, and/or links to the corresponding attribution data 248. The generated audio data 250 may be stored in various digital audio formats including, but not limited to, WAV, MP3, FLAC, AAC, or MIDI formats. In some embodiments, the generated audio data 250 may include multiple versions or variations of a generated content item, such as different renderings using alternative instrument selections, modified sections, and/or genre-swapped versions. The memory 240 may retain the generated audio data 250 for subsequent retrieval, modification, playback, distribution, and/or licensing purposes, in embodiments.

In some embodiments, the seed acquisition module 272 may identify and/or receive number of seed tracks. The seed acquisition module 272 may implement multiple seed acquisition strategies to obtain seed tracks that are similar to one another in a particular style corresponding to a desired output (e.g., as identified by a user request).

In some embodiments, the seed acquisition module 272 may receive or otherwise identify a natural language request (e.g., as provided by a user of client device 101 of FIG. 1). In some embodiments, the natural language request may be provided directly by the user through the audio generation interface 175 (e.g., as a user request). In some embodiments, the audio generation system 172 may automatically generate a natural language prompt based on user request. For example, the audio generation system 172 may receive a user request and automatically generate a formatted natural language prompt by extracting musical variables from the user request and formulating the prompt to include or imply the identified musical variables. The musical variables may include song structure, genre of music, beats per minute (BPM), chord progression, key, musical style, melody, harmony, rhythm, timing, timbre, and/or note density. The seed acquisition module 272 may receive the natural language prompt, whether user-provided or automatically generated, and may parse the prompt for relevant keyword information to identify seed tracks from the training dataset 242.

An illustrative example of a natural language prompt may be “generate an upbeat workout song for running on the beach.” The seed acquisition module 272 may process the natural language prompt for relevant keywords. In some embodiments, the seed acquisition module 272 may parse the prompt for relevant keyword information and/or for song specifics, such as instruments, key, genre, beats per minute, mood, style, and/or other musical characteristics. The seed acquisition module 272 may translate the natural language prompt into musical elements by identifying keywords that correspond to tags or labels in the preprocessed training dataset 242. The seed acquisition module 272 may search the training dataset (e.g., training dataset 242) for tracks that are most relevant to the keywords. That is, the seed acquisition module 272 may search the training data set 242 for the keyword information to identify seed tracks that represent the user's intent corresponding to the user request (e.g., seed tracks that represent that the user is requesting the generative AI model to generate). The seed tracks become the basis for further generation. In some embodiments, the seed acquisition module 272 may identify five, ten, or any other manageable number of seed tracks. In some embodiments, the seed acquisition module 272 may store the identified seed tracks in seed data 246.

In some embodiments, the seed acquisition module 272 may receive seed tracks from a user, e.g., from client device 101. For example, a user of client device 101 may provide a list of seed tracks on which to base the generation of new music. For example, a user may specify an existing album's tracks as the seeds, which the audio generation system 172 may use to generate songs that fit the album's instrumentation and style. In some embodiments, the seed acquisition module 272 may receive an indication of a song, collection of songs, and/or artist from a user, and may identify seed tracks based on the indication.

In some embodiments, the seed acquisition module 272 may perform a sonic search of the training dataset 242 to identify seed tracks. A sonic search may be described as an audio-based search that identifies audio clips, sound patterns, and/or songs using audio fingerprints or other audio similarity techniques. The seed acquisition module 272 may perform a sonic search based on a song, collection of songs, and/or artist indicated by a user or determined based on user input to identify a number of representative tracks from the training dataset 242 that sound similar to the indicated or selected song, collection of songs, and/or artist. The seed acquisition module 272 may use the identified representative tracks as seed tracks for generating new content items. This sonic search approach may be used when the user does not have access to rights for specific tracks or when generating derivatives based on existing musical works, for example.

In some embodiments, the seed acquisition module 272 may identify seed tracks based on a target genre for genre swapping operations. The seed acquisition module 272 may search the training dataset 242 for tracks that match a specified target genre, which may then be used by the genre swapping module 284 to transform an existing track from a source genre to the target genre while maintaining structural elements of the original track.

In some embodiments, the rapid fine-tuning module 274 may ensure that the seed tracks are the primary influence in the ensuing generations from the trained generative AI model(s) 276. Rapid fine-tuning may be used for composition-based models as well as diffusion-based models, and/or any model that supports fine-tuning or context windows to guide the model's output. In some embodiments, the rapid fine-tuning module 274 may perform rapid fine-tuning of an LLM by providing the seed tracks in the context window of the LLM, thereby instructing the LLM to generate new musical content based on the provided seed tracks. The rapid fine-tuning module 274 may force the generative AI model(s) 276 to use the identified seed tracks as its basis for generation. For example, the rapid fine-tuning module 274 may ensure that the seed tracks constitute a majority influence (e.g., approximately 80%) on the generated output while the model's broader training provides only minor details (e.g., approximately 20%).

In some embodiments, the rapid fine-tuning process may ensure that the seed tracks constitute a majority influence on the generated output, such that approximately 80% to 90% of the musical characteristics in the generated composition are derived from the seed tracks, while approximately 10% to 20% are derived from the broader global knowledge of the training dataset. The rapid fine-tuning module 274 may achieve this influence ratio through parameter adjustment techniques that heavily prioritize the seed tracks during the generation process.

In some embodiments, the rapid fine-tuning module 274 may fine-tune the generative AI model(s) using the seed tracks. That is, the rapid fine-tuning module 274 may further train the generative AI model(s) 276 on the seed tracks by adjusting the model parameters. The further training may involve modifying weights, biases, and/or other parameters of the generative AI model(s) 276 to heavily weight the seed tracks in the generation process while maintaining the model's global knowledge of the training dataset 242. The parameter adjustments may result in trained AI model(s) 276 that generate new content items that are heavily influenced by the seed tracks. This approach may be particularly useful when generating a large number of tracks (e.g., hundreds) based on the same seed tracks, as the fine-tuned model may be used repeatedly without requiring the seed tracks to be provided with each generation request.

In some embodiments, the rapid fine-tuning module 274 may assign different weights to different seed tracks to control their relative influence on the generated output. The weighting mechanism may enable precise control over how each seed track influences the generated musical composition. The rapid fine-tuning module 274 may assign a higher weight to a primary seed track to serve as the dominant influence on the generated output, while assigning lower weights to secondary seed tracks to contribute specific musical details or characteristics to the final composition.

In some embodiments, the rapid fine-tuning module 274 may receive weight assignments for one or more of the seed tracks in the seed data 246. The weight assignments may specify the degree to which each seed track should influence the generation process. For example, a first seed track may be assigned a weight of 60%, a second seed track may be assigned a weight of 25%, and a third seed track may be assigned a weight of 15%, such that the first seed track has the greatest influence on the generated composition while the second and third seed tracks contribute progressively less influence.

In some embodiments, the rapid fine-tuning module 274 may adjust the parameters of the generative AI model(s) 276 based on the assigned weights. When performing literal fine-tuning, the rapid fine-tuning module 274 may modify the weights, biases, and/or other learnable parameters of the neural network architecture to prioritize the seed tracks according to their assigned weights. The seed tracks with higher assigned weights may have a greater impact on the parameter adjustments, while seed tracks with lower assigned weights may have a lesser impact.

Additionally or alternatively, the rapid fine-tuning module 274 may include the seed tracks in the prompt context window of the generative AI model(s) 276. In some embodiments, the rapid fine-tuning module 274 may provide the seed tracks along with the generation prompt as input to the generative AI model(s) 276 without modifying the underlying model parameters. For example, when the generative AI model(s) 276 include an LLM, the rapid fine-tuning module 274 may include the musical elements from the seed tracks in the context window of the LLM query, thereby guiding the LLM to generate new musical content that is heavily influenced by the seed tracks. In this approach, the rapid fine-tuning module 274 may format the seed data 246 and the prompt into a single input that instructs the generative AI model(s) 276 to generate new music based on the provided seed tracks. The context window approach may be preferable when generating a single content item or a small number of content items, as it may be faster than performing literal fine-tuning of the model parameters. The choice between literal fine-tuning and context window approaches may depend on factors such as the size of the context window, the amount of data associated with the seed tracks, the number of content items to be generated, and/or the desired generation speed.

In some embodiments, when using the context window approach, the rapid fine-tuning module 274 may format the seed data 246 to emphasize the seed tracks according to their assigned weights. The seed tracks with higher weights may be provided with greater prominence in the context window, such as by including more detailed musical information, repeating certain musical elements, and/or positioning the data earlier in the context window where it may have greater influence on the model's generation process.

In some embodiments, the audio generation system 172 may receive weight assignments from a user through the audio generation interface 175. The user may specify which seed track(s) should have greater or lesser influence on the generated output. In some embodiments, the audio generation system 172 may automatically determine weight assignments based on factors such as the relevance of each seed track to the user request, the similarity of each seed track to other seed tracks in the set, and/or the musical characteristics of each seed track.

In some embodiments, the rapid fine-tuning module 274 may determine whether to use literal fine-tuning or the context window approach based on an evaluation of one or more factors. In some embodiments, the rapid fine-tuning module 274 may assess the size of the context window available in the generative AI model(s) 276 and compare it to the amount of data associated with the seed tracks in seed data 246. If the context window is sufficiently large to accommodate all the seed track data (including musical notes, positions, key, chord progressions, instrument choice, genre, note density, beats per minute, and song structure information), the rapid fine-tuning module 274 may select the context window approach. If the seed track data exceeds the available context window size, the rapid fine-tuning module 274 may select the literal fine-tuning approach.

In some embodiments, the rapid fine-tuning module 274 may consider the number of content items to be generated from the same set of seed tracks. When a large number of content items (e.g., hundreds of tracks) are to be generated using the same seed tracks, the rapid fine-tuning module 274 may determine that literal fine-tuning is more efficient, as the fine-tuned model may be used repeatedly without requiring the seed tracks to be provided with each generation request. Conversely, when only a single content item or a small number of content items are to be generated, the rapid fine-tuning module 274 may determine that the context window approach is preferable, as it may be faster than performing literal fine-tuning of the model parameters.

In some embodiments, the rapid fine-tuning module 274 may evaluate the desired generation speed or time constraints. The rapid fine-tuning module 274 may calculate or estimate the time required for literal fine-tuning versus the time required for context window processing. Rapid generation may be preferable when a user requests immediate generation of a content item, when only a single content item or a small number of content items are to be generated, when time constraints are imposed by the user or application requirements, and/or when real-time or near-real-time music generation is needed. The rapid fine-tuning module 274 may determine that rapid generation is preferable by detecting that only a single or small number of content items are being requested, receiving explicit user input indicating a need for quick generation, evaluating system-level time constraints or deadlines associated with the generation request, analyzing the application context or use case, and/or receiving priority flags or urgency indicators in the generation request. When rapid generation is preferable and the context window can accommodate the seed track data, the rapid fine-tuning module 274 may select the context window approach. When time constraints are less stringent and/or multiple generations are anticipated, the rapid fine-tuning module 274 may select literal fine-tuning to optimize overall processing efficiency across multiple generation request.

In some embodiments, the rapid fine-tuning module 274 may use both approaches in sequence. For example, a track may initially be provided through the context window for immediate generation, and subsequently the same track may be incorporated into the training dataset 242 during a model update, effectively becoming part of the fine-tuned model for future generations.

In some embodiments, the audio creation governing module 278 may implement one or more generative AI model(s) 276 to generate audio data (e.g., musical compositions). The one or more generative AI model(s) 276 may be trained on the training dataset 242, and may be rapid fine-tuned on the seed data 246 by rapid fine-tuning module 274. The generative AI model(s) 276 may include one or more trained neural network models, machine learning algorithms, and/or other artificial intelligence architectures configured to generate audio content based on input data and prompts. In some embodiments, the generative AI model(s) 276 may include an LLM trained to generate musical compositions. The audio creation governing module 278 may provide the seed tracks and a prompt to the LLM, and the LLM may output a new musical composition based on the seed tracks and the prompt using a retrieval-augmented generation (RAG) approach.

In some embodiments, each generative AI model of the one or more AI model(s) 276 may be trained to generate a distinct section of a content item. For example, for a musical content item, the sections can include an intro, verse, chorus, bridge, outro, etc. In some embodiments, the audio creation governing module 278 may extract song structure data from the seed data 246 to identify the arrangement and sequence of sections in the seed tracks. In some embodiments, the audio creation governing module 278 may implement each trained and rapid fine-tuned generative AI model 276 to generate a corresponding section of a content item. For each section to be generated, the audio creation governing module 278 may use the corresponding sections from the seed tracks for rapid fine-tuning. For example, to generate an intro for a new content item, the audio creation governing module 278 may cause the rapid fine-tuning module 274 to rapid fine-tune a generative AI model using only the intros from the seed tracks.

In some embodiments, the generative AI model(s) 276 may include different types of AI models optimized for generating different types of song sections or musical elements. In some embodiments, the audio creation governing module 278 may implement specialized models rather than (or in addition to) relying on a single full-song generative model. For example, the audio creation governing module 278 may use a drum-specific model for generating drum lines, a vocal model for generating singing portions, and/or one or more additional models for generating other musical elements, such as melody, harmony, and/or accompaniment. In some embodiments, the audio creation governing module 278 may perform rapid-fine tuning of each specialized model using the seed tracks to maintain consistency across all generated sections and/or musical elements.

In some embodiments, the generative AI model(s) 276 may include one or more in-painting models configured to modify an existing musical composition. The existing musical composition may be a musical composition of an actual performance or may be a synthetic composition e.g., previously or partly generated by the audio generation system 172. The in-painting model may take an existing music track (e.g., a song) and append, prepend, and/or replace a section of the music track. The in-painting model may draw upon the existing music track itself as a basis for determining instruments and/or musicality, and/or upon the seed data 246 representing the model's knowledge about music derived from seed tracks.

In some embodiments, the in-painting model may analyze the existing track to identify musical characteristics such as instrumentation, key, tempo, harmonic progression, and/or stylistic elements. The in-painting model may used these identified characteristics to ensure that the appended, prepended, and/or replaced section maintains consistency with the existing track. In some embodiments, the in-painting model may draw upon the seed data 246 to incorporate musical patterns, structures, and/or characteristics learned from the seed tracks during the rapid fine-tuning process.

In some embodiments, the operation of the in-painting model may differ depending on the type of section being generated. In some embodiments, when in-painting unique musical sections such as bridges or pre-choruses that may not have analogous sections elsewhere in the existing track, the in-painting model may primarily rely on the seed data 246 to determine the musical structure and/or characteristics of the section. For example, when generating a bridge for a song that does not already contain a bridge, the in-painting model may analyze the bridges from the seed tracks to determine typical musical characteristics, harmonic departures, and/or structural functions of bridge sections, and may generate a new bridge that incorporates these characteristics while maintaining consistency with the instrumentation and overall style of the existing song.

In some embodiments, when in-painting common sections such as choruses or verses that have analogous sections elsewhere in the existing track, the in-painting model may primarily draw upon the existing sections from the same track as reference material. For example, when generating an additional chorus for a track that already contains one or more choruses, the in-painting model may analyze the existing choruses to identify melodic patterns, harmonic progressions, rhythmic structures, and/or lyrical patterns. The in-painting model may generate a new chorus that closely resembles the existing choruses while optionally incorporating variations and/or developments learned from the seed data 246.

In some embodiments, the use of specialized models for different section types or musical elements may enable the audio generation system 172 to generate sections that are suited to their structural and/or musical function within the composition. Each specialized model may be trained and rapid fine-tuned on data specific to its domain, allowing for more precise and musically appropriate generation compared to a single generalized model.

In some embodiments, the audio creation governing module 278 may generate a sub-prompt for each AI model that represents the user request received from the user device, and optionally that includes the seed data 246. The generated sub-prompts represent the user request received from the user device by including or implying musical variables identified from the original user request, such as genre of music, BPM, chord progression, key, musical style, melody, harmony, rhythm, timing, timbre, note density, etc. Each generated sub-prompt may be tailored for the particular AI model and the specific section to be generated. The audio creation governing module 278 may combine the sections generated by each AI model according to the song structure data to create a complete composition of a new content item.

As illustrative examples, a first user request may be “I want calm background music for a spa or meditation session,” and the audio creation governing module 278 may generate a main prompt such as “generate a calm, ambient composition with slow tempo between 60-80 BPM, minor or modal key tonality, soft dynamics, minimal percussion, and instrumentation suitable for relaxation such as piano, strings, or synthesizer pads.” The audio creation governing module 278 may generate sub-prompts for each AI model, such as “generate a gentle, fading-in intro with soft ambient textures for a spa meditation track” for an intro-generating AI model, and “generate a flowing, meditative verse section with sustained notes and minimal rhythmic activity for a relaxation composition” for a verse-generating AI model. As another illustrative example, a second user request may be “create festive music for a winter holiday advertisement,” and the audio creation governing module 278 may generate a main prompt such as “generate a festive, cheerful composition with moderate tempo between 100-120 BPM, major key tonality, bright and warm timbre, and instrumentation characteristic of holiday music such as bells, orchestral strings, and woodwinds.” The audio creation governing module 278 may generate sub-prompts such as “generate a bright, attention-grabbing intro with bell tones and building energy for a holiday advertisement” for an intro-generating AI model, and “generate an uplifting, memorable chorus with full orchestration and celebratory feel for a winter holiday commercial” for a chorus-generating AI model.

In some embodiments, the audio generation system 172 may enable a user to modify individual notes in the generated composition. In some embodiments, the audio generation system 172 may receive user input (e.g., from a user of client device 101 of FIG. 1) indicating a modification to one or more notes in the composition, such as changing the pitch, duration, and/or timing of a note. The audio creation governing module 278 may update the compositional data to reflect the modified notes and may regenerate the affected portion of the composition. In some embodiments, the modified composition may be re-rendered into audio format using the previously identified virtual instruments, or the user may request different instruments for the modified sections.

In some embodiments, the audio generation system 172 may enable a user to regenerate specific sections of the generated composition. The audio generation system 172 may receive user input (e.g., from a user of client device 101 of FIG. 1) indicating a request to regenerate a particular section, such as a verse, chorus, or bridge. The audio creation governing module 278 may implement the appropriate rapid fine-tuned generative AI model 276 to generate a new version of the specified section while maintaining the other sections of the composition unchanged. In some embodiments, the user may provide additional parameters and/or constraints for the regenerated section, such as a different mood, style, and/or instrumentation. The audio creation governing module 278 may incorporate the regenerated section into the complete composition and may coordinate with the instrument comparison module 280 and the audio rendering module 288 to render the updated composition into audio format.

In some embodiments, the generative AI model(s) 276 may include one or more trained neural network models, machine learning algorithms, and/or artificial intelligence architectures configured to generate musical content based on input data and prompts. The generative AI model(s) 276 may include transformer-based models, large language models (LLMs), diffusion models, generative adversarial networks (GANs), variational autoencoders (VAEs), recurrent neural networks (RNNs), and/or other deep learning architectures suitable for audio and/or music generation. In some embodiments, the generative AI model(s) 276 may include an LLM that has been trained on musical data and configured to generate musical compositions based on seed tracks and user request(s). The generative AI model(s) 276 may be trained on the training dataset 242 to learn patterns, structures, and/or relationships within musical data, including harmony, melody, rhythm, chord progressions, instrumentation, and/or song structure. Through the training process, the generative AI model(s) 276 may learn to identify and replicate musical characteristics such as genre-specific patterns, stylistic elements, and/or compositional techniques. The generative AI model(s) 276 may utilize attention mechanisms, encoder-decoder architectures, latent space representations, and/or other machine learning techniques to process prompts and seed track data and produce musical compositions that exhibit characteristics similar to the seed tracks while maintaining novelty. In some embodiments, the generative AI model(s) 276 may generate output in the form of compositional data representing musical notes, positions, timing, and/or instrument assignments. In some embodiments, the output of the generative AI model(s) 276 may be subsequently rendered into audio format. In some embodiments, the generative AI model(s) 276 may support fine-tuning operations that adjust model parameters to emphasize specific training examples, and/or may support a context window approach that allows seed track data to be provided as part of the prompt without modifying the underlying model parameters.

In some embodiments, the instrument comparison module 280 may identify instruments or instrument data used in the seed tracks. The instrument comparison module 280 may analyze the seed tracks to determine which musical instruments are present in each seed track and extract audio characteristics associated with those instruments. In some embodiments, the instrument data of the seed tracks may be determined during the preprocessing of the training dataset 242. For example, the preprocessing of the training dataset 242 can include music information retrieval operations that identify and tag the instruments used in each track.

In some embodiments, the instrument comparison module 280 may generate a vector representation of the audio corresponding to the seed data 246. The instrument comparison module 280 may use a pre-trained audio neural network, such as a pre-trained audio neural networks (PANNs) model, to generate vector representations of audio samples from the seed tracks. The vector representations may encode audio characteristics such as timbre, tone, and/or spectral features that distinguish different instruments. In some embodiments, the instrument comparison module 280 may isolate portions of each seed track by instrument to generate separate vector representations for each instrument type present in the seed tracks.

In some embodiments, the instrument comparison module 280 may compare the vector representation (and/or other instrument data) with instrument data 244 to identify which digital instruments sound most like to the instruments used in the seed data 246. The instrument data 244 may include a library of virtual instruments, each associated with its own vector representation generated using the same pre-trained audio neural network. The instrument comparison module 280 may perform similarity comparisons between the vector representations from the seed tracks and the vector representations of the virtual instruments in instrument data 244. The instrument comparison module 280 may calculate similarity scores or distance metrics to determine the closest matches. The instrument comparison module 280 may identify a number of virtual instruments from the instrument data 244 that most closely resemble the instruments used in the seed tracks based on the comparison results.

In some embodiments, the audio generation system 172 may then use the identified instrument data to render the composition of the new content item (e.g., as generated by audio creation governing module 278) into an audio song or track. The rendering process may involve assigning the identified virtual instruments to the corresponding parts of the composition and generating digital audio output using the selected virtual instruments. The audio generation system 172 may store the complete composition of the new content item, the identified instruments, and/or the rendered audio as generated audio data 250.

In some embodiments, the audio generation system 172 may enable a user to modify the instruments used in the rendered composition. The audio generation system 172 may receive user input (e.g., from a user of client device 101 of FIG. 1) specifying a different virtual instrument to replace an instrument in the composition. For example, a user may request to change a piano part to a guitar part, or to use a different piano model from the instrument data 244. The instrument comparison module 280 may identify the requested virtual instrument from the instrument data 244 and the audio rendering module 288 may re-render the composition using the selected virtual instrument. In some embodiments, the user may override the automatically selected instruments for one or more tracks in the composition, and the audio rendering module 288 may re-render the affected portions of the composition with the user-specified instruments.

In some embodiments, the audio rendering module 288 may render compositional data into audio format using virtual instruments. The audio rendering module 288 may receive compositional data from the audio creation governing module 278, which may include musical notes, positions, timing, and/or instrument assignments for each part of the composition. The audio rendering module 288 may also receive instrument selections from the instrument comparison module 280. The instrument selections from the instrument comparison module 280 identify the virtual instruments from instrument data 244 that most closely match the instruments used in the seed track.

In some embodiments, the audio rendering module 288 may access the instrument data 244 to retrieve the selected virtual instruments. The audio rendering module 288 may assign the identified virtual instruments to the corresponding parts of the composition based on the instrument assignments provided by the audio creation governing module 278. The audio rendering module 288 may generate digital audio output by processing the compositional data through the virtual instruments, thereby converting the compositional representation (similar to sheet music) into audible audio.

In some embodiments, the audio rendering module 288 may merge the audio outputs from multiple virtual instruments to create a final audio file. The audio rendering module 288 may store the rendered audio as generated audio data 250, optionally along with the compositional data and/or metadata associated with the generated content item. The rendered audio may be stored in various digital audio formats including, but not limited to, WAV, MP3, FLAC, AAC, or other suitable audio formats.

In some embodiments, the audio rendering module 288 may perform re-rendering operations in response to user modifications. When a user modifies notes in the composition through the audio creation governing module 278, the audio rendering module 288 may re-render the affected portions of the composition using the previously identified virtual instruments. When a user changes instruments through the instrument comparison module 280, the audio rendering module 288 may re-render the composition using the newly selected virtual instruments. The audio rendering module 288 may update the generated audio data 250 with the re-rendered audio output.

In some embodiments, the audio rendering module 288 may coordinate with the audio creation governing module 278 and the instrument comparison module 280 to ensure that the rendered audio accurately reflects the compositional data and uses the appropriate virtual instruments. In some embodiments, the audio rendering module 288 may apply audio processing techniques such as mixing, balancing, and/or effects to produce a polished final audio output that maintains the sonic characteristics of the seed tracks.

In some embodiments, the derivative generation module 282 may generate one or more derivatives of a specific song, collection of songs (e.g., album), and/or artist. The derivative generation module 282 may enable the creation of new musical content items that are stylistically similar to or inspired by existing musical works while maintaining the attribution capabilities of the audio generation system 172. In some embodiments, rather than identifying the set of seed tracks from a user request containing musical parameters or keywords, the audio generation system 172 may receive an indication of a song, collection of songs, and/or artist from a user, and the derivative generation module 282 may identify seed tracks based on the indication.

In some embodiments, the derivative generation module 282 may perform a sonic search of the training dataset 242 based on the song, collection of songs, and/or artist to identify a number of tracks in the training dataset 242 that sound similar to the indicated the song, collection of songs, and/or artist. A sonic search may be described as an audio-based search that identifies audio clips, sound patterns, or songs using audio fingerprints or other audio similarity techniques. The derivative generation module 282 may analyze audio characteristics such as timbre, rhythm, melody, harmony, instrumentation, and/or genre to identify representative tracks from the training dataset 242 that match the sonic profile of the indicated song, collection of songs, or artist. The derivative generation module 282 may store the representative tracks in seed data 246 as the seed tracks for the generation process.

In some embodiments, the derivative generation module 282 may coordinate with the rapid fine-tuning module 274 to rapid fine-tune the generative AI model(s) 276 using the identified representative tracks. The derivative generation module 282 may implement the audio creation governing module 278 to generate a composition of a new content item that is a derivative of the identified song, collection of songs, and/or artist (e.g., as indicated in the user request). In some embodiments, the derivative generation module 282 may implement the instrument comparison module 280 to identify and select virtual instruments that match the instruments used in the representative tracks, thereby ensuring that the derivative content item maintains sonic characteristics similar to the original song, collection of songs, and/or artist.

In some embodiments, the genre swapping module 284 may implement a genre transformation process that converts a musical track from one genre to another while preserving structural elements of the original track. The genre swapping module 284 may receive or identify a particular track. The particular track may be a track of an actual performance or may be a synthetic track output by the generative AI model(s) 276. The genre swapping module 284 may receive or identify a request to change the genre of the particular track to a specified target genre.

In some embodiments, the genre swapping module 284 may identify the structural data of the particular track, including, for example, the song structure data, the chord progression, and/or the key. The structural data may be extracted through music information retrieval operations or may be retrieved from preprocessed metadata associated with the particular track. By identifying and preserving these structural elements, the genre swapping module 284 may ensure that the transformed track maintains the fundamental musical framework of the original while adopting the stylistic characteristics of the target genre.

In some embodiments, the genre swapping module 284 may identify seed tracks from the training dataset 242 that match the target genre. The identification process may involve searching the training dataset 242 for tracks that are tagged or labeled with the target genre. The genre swapping module 284 may store the seed tracks as seed data 246 for use in the rapid fine-tuning process.

In some embodiments, the genre swapping module 284 may coordinate with the rapid fine-tuning module 274 to rapid fine-tune the generative AI model(s) 276 using the identified seed tracks that match the target genre. The genre swapping module 284 may provide the structural data of the particular track (such as the chord progression, key, and/or song structure) along with a prompt to the audio creation governing module 278. The audio creation governing module 278 may use the rapid fine-tuned generative AI model(s) 276 to generate a new composition that maintains the structural elements of the particular track while incorporating the stylistic characteristics of the target genre as learned from the seed tracks. The genre swapping module 284 may also implement the instrument comparison module 280 to identify and select virtual instruments that are characteristic of the target genre, thereby ensuring that the genre-swapped track exhibits authentic sonic qualities associated with the target genre.

In some embodiments, the attribution module 286 may determine an attribution breakdown for the new content item based on the set of tracks used to rapid fine-tune the generative AI model(s) 276. The attribution breakdown may reflect the collection rights for the newly generated track. The attribution breakdown may specify the allocation of rights and royalties among the seed track rights holders, the user who provided the user request, and the organization maintaining the audio generation system 172.

The attribution breakdown may mirror the rights of the seed tracks. That is, the attribution is evenly divided among the seed tracks. In some embodiments, the rights of the seed tracks may be stored as seed data 246 and may include copyright information and/or royalty information. As an illustrative example, the seed acquisition module 272 may identify five seed tracks. The rights of two of the five seed tracks are owned by A, and the rights of the other three seed tracks are owned by B, C, and D, respectively. The attribution module 286 may allocate 40% of the rights of the newly generated song (or track) to A, and 20% of the rights to each of B, C, and D.

In some embodiments, the attribution breakdown may include a certain percentage of the rights (e.g., 25%) attributed to the user (e.g., of user device 101) that provided the user request that resulted in the creation of the new song or track, a certain percentage (e.g., 25%) may attributed to the organization that built, runs, and/or maintains the audio generation system 172, and the remainder (e.g., 50%) evenly divided among the seed tracks. As an illustrative example, 25% of the rights may be attributed to the user, 25% may be attributed to the organization that built, runs, and/or maintains the audio generation system 172, and the other 50% may be evenly divided among the seed tracks. Other attribution breakdowns may be used. The attribution module 286 may store the attribution breakdown as attribution data 248. The attribution module 286 may provide the attribution breakdown to a user device (e.g., client device 101 of FIG. 1), along with the generated new content item.

In some embodiments, the attribution module 286 may determine the attribution breakdown based on the assigned weights (e.g., as described with respect to the rapid fine-tuning module 274). The attribution breakdown may allocate rights and royalties to the seed track rights holders in proportion to the weights assigned to their respective seed tracks. For example, if a first seed track is assigned a weight of 60% and a second seed track is assigned a weight of 40%, the attribution breakdown may allocate 60% of the seed track portion of the rights to the rights holders of the first seed track and 40% to the rights holders of the second seed track. This weighted attribution approach may provide a more accurate reflection of each seed track's contribution to the generated content item.

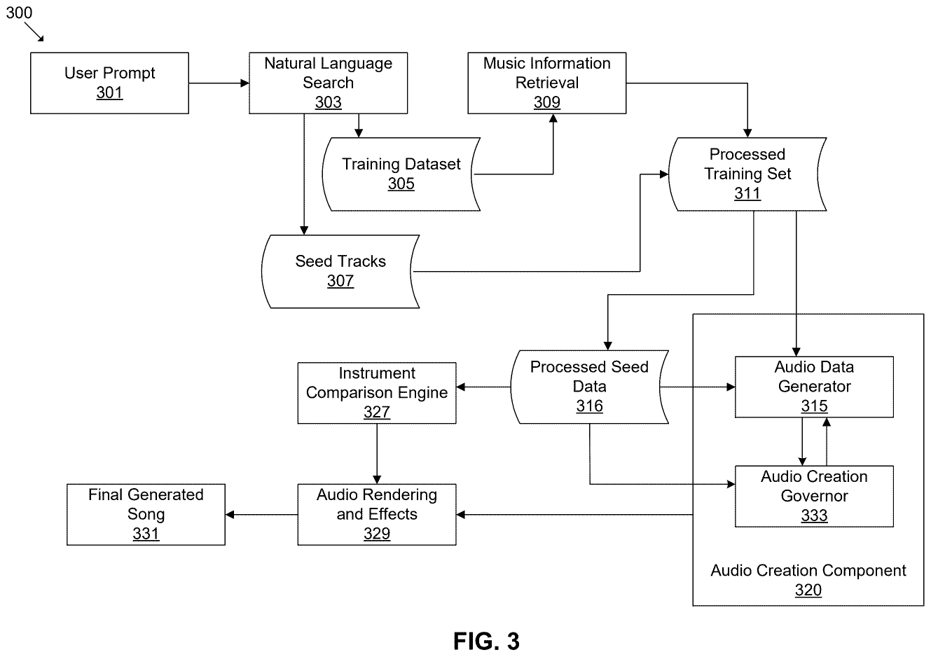

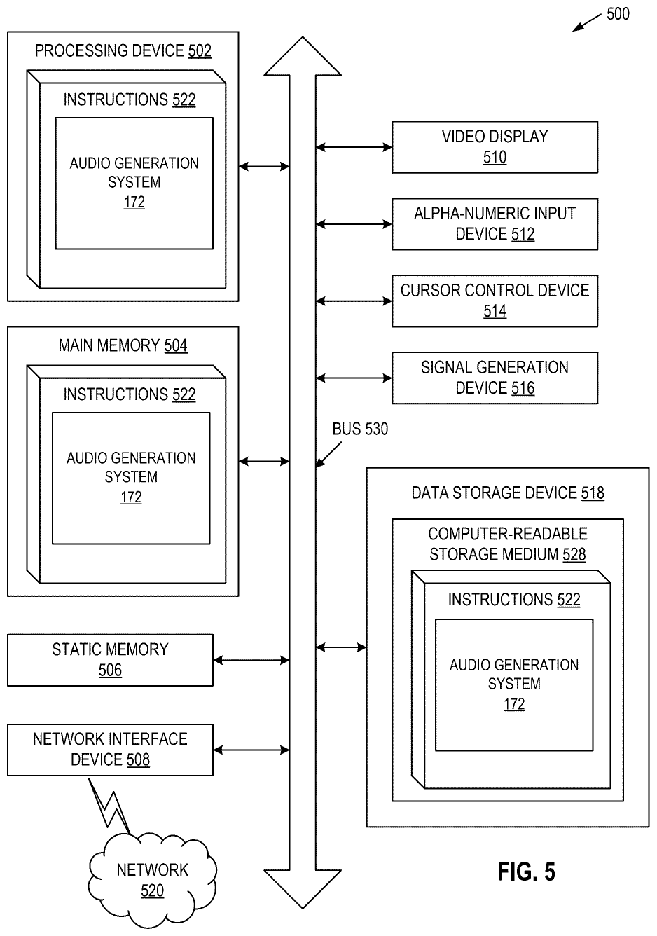

FIG. 3 is a block diagram illustrating an workflow 300 for generating a new audio content item using a generative AI model that is rapid fine-tuned on a set of seed tracks, in accordance with some embodiments of the present disclosure. The workflow 300 may be performed by processing logic executed by a processor of a computing device. The workflow 300 may be implemented, for example, by one or more audio generation system 172 of FIG. 1 executing on a processing device 502 of computing device 500 shown in FIG. 5. The operations and/or methods described with reference to FIG. 3 may be performed by processing logic that may comprise hardware (e.g., circuitry, dedicated logic, programming logic, microcode, etc.), software (e.g., instructions run on a processing device to perform hardware simulation), or a combination thereof. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process workflows are possible.

In some embodiments, at operation 301, the processing logic may receive a user request from a user (e.g., of client device 101 of FIG. 1). The user request may be a natural language request that describes desired characteristics of the musical content to be generated. In some embodiments, the user request may include descriptive text such as “workout music for running on the beach” or other natural language descriptions that convey musical intent.

In some embodiments, the processing logic may receive the user request through the audio generation interface 175 of FIG. 1, which may provide various input mechanisms for users to specify their generation requests. In some embodiments, the audio generation interface 175 may provide a dropdown menu from which the user can select a pre-defined request. In some embodiments, the audio generation interface 175 may provide a text input field that enables the user to enter a custom natural language request. The user request may include general descriptive terms such as mood, activity, and/or setting, and/or may include specific musical parameters such as instruments, key, genre, tempo, and/or style.

In some embodiments, the user request may specify particular seed tracks to be used in the generation process. For example, rather than providing a descriptive natural language request, the user may indicate specific songs, an album, and/or an artist to serve as the basis for generation. For example, the user may specify the titles and/or artists of desired seed tracks, may indicate a particular album whose tracks should be used as seeds, and/or may upload audio files to be used as seed tracks. This approach may be used when the user desires to generate derivative works or additional content that matches the style and instrumentation of existing musical works.

In some embodiments, the processing logic may parse the user request for relevant keyword information and song specifics. The processing logic may identify keywords related to musical characteristics such as genre, mood, style, tempo, instrumentation, key, and/or other musical attributes. The processing logic may also identify any explicitly mentioned musical parameters such as specific instruments, beats per minute, chord progressions, and/or song structure elements. The extracted keyword information and musical parameters may be used in subsequent operations to identify appropriate seed tracks.

At operation 303, the processing logic may perform a natural language search of the training dataset 305 or other dataset to identify a set of seed tracks 307 (e.g., five or ten seed tracks). The training dataset 305 may correspond to training dataset 242 of FIG. 2. Alternatively, or additionally, the dataset may include tracks of the training dataset as well as additional tracks not used for training (e.g., which may be accessible to the system such as via a connected data store or as additional tracks that are included in the prompt). The processing logic may translate the natural language request into musical elements by identifying keywords that correspond to tags or labels in the training dataset 305. The training dataset 305 may be preprocessed and tagged with musical information including genre, key, moods, styles, beats per minute, chord progressions, note density, song structure, instrumentation, and/or other musical characteristics. In some embodiments, the training dataset 305 may include thousands or tens of thousands of tags or labels associated with each track. At operation 303, the processing logic may search the training dataset 305 for tracks that match the identified keywords and/or musical parameters from the user request. The processing logic may identify a manageable number of seed tracks 307, such as five to ten tracks, that are most representative of the user's intent as expressed in the user request. In some embodiments, the identified seed tracks 307 may serve as the primary basis for all further generation operations.

In some embodiments, the processing logic may process the training dataset 305 by performing music information retrieval operation 309 on the training dataset 305 to generate processed training set 311. In some embodiments, the processing logic may perform the music information retrieval 309 on the entire set of training data tracks 305, including the identified seed tracks 307, to generate the processed training dataset 311. The music information retrieval operation 309 may analyze audio data from the training dataset 305 to extract musical characteristics and/or compositional information. In some embodiments, the music information retrieval operation 309 may extract the equivalent of sheet music from the training data tracks 305, including the identification of individual musical notes and their positions within each track. In some embodiments, the music information retrieval operation 309 may identify and extract musical qualities including key, chords, chord progressions, instrument choice, genre, note density, beats per minute (BPM), song structure, melody, harmony, rhythm, timing, and/or timbre from the training dataset 305.

In some embodiments, the music information retrieval operation 309 may include tagging each track in the training dataset 305 with the extracted musical information. The tags may include thousands or tens of thousands of labels associated with each track, organized into categories such as genre, key, moods, styles, beats per minute, chord progressions, note density, and/or song structure, for example.

In some embodiments, the music information retrieval operation 309 may be performed on the entire training dataset 305 prior to receiving user requests for music generation. The preprocessing and tagging performed by the music information retrieval operation 309 may enable efficient natural language searching to identify seed tracks that match specific musical criteria or user request by translating natural language requests into musical elements through the tagged tracks. The processed training dataset 311 generated by the music information retrieval operation 309 may include the extracted compositional data, musical characteristics, and/or associated tags for each track in the training dataset 305.

In some embodiments, the processing logic may identify the processed seed data 316 from the processed training set 311 using the seed tracks 307 identified at operation 303. The processed seed data 316 may include the subset of data from the processed training set 311 that corresponds to the identified seed tracks 307. The processed seed data 316 may include the extracted compositional data, musical characteristics, and/or tags associated with each of the seed tracks 307, including musical notes and positions (equivalent to sheet music), key, chords, chord progressions, instrument choice, genre, note density, beats per minute, song structure, melody, harmony, rhythm, timing, and/or timbre. In some embodiments, the processing logic may retrieve the processed seed data 316 by accessing the preprocessed and tagged information for the seed tracks 307 from the processed training set 311, thereby avoiding the need to perform music information retrieval operations on the seed tracks 307 at generation time.

In some embodiments, the processed training set 311 and/or the processed seed data 316 is provided to the audio creation component 320. The audio creation component 320 includes an audio data generator 315 and an audio creation governor 333. In some embodiments, the audio creation component 320 produces a song composition.

In some embodiments, the processed training set 311 may be used to train audio data generator 315. The audio data generator 315 may be or include one or more generative AI models configured to generate audio compositions based on input data and prompts. The audio data generator 315 may correspond to generative AI model(s) 276 of FIG. 2. The generative AI model(s) may include transformer-based models, LLMs, diffusion models, generative adversarial networks (GANs), variational autoencoders (VAEs), recurrent neural networks (RNNs), or other deep learning architectures suitable for audio or music generation.

In some embodiments, the AI model(s) of the audio data generator 315 may be trained using the processed training set 311. The training process may involve providing the processed training set 311 to the generative AI model(s) to enable the model(s) to learn patterns, structures, and relationships within musical data. The processed training set 311 may include compositional data, musical characteristics, and tags for thousands or millions of tracks, including musical notes and positions, key, chords, chord progressions, instrument choice, genre, note density, beats per minute, song structure, melody, harmony, rhythm, timing, and timbre. Through the training process, the generative AI model(s) may learn to identify and replicate musical characteristics such as genre-specific patterns, stylistic elements, and compositional techniques.

In some embodiments, the training may involve adjusting model parameters through iterative optimization processes to minimize loss functions and improve the model's ability to generate musical compositions that exhibit characteristics similar to the training data. The generative AI model(s) may utilize attention mechanisms, encoder-decoder architectures, latent space representations, or other machine learning techniques to process the processed training set 311 and develop the capability to generate novel musical content.

In some embodiments, the trained generative AI model(s) may maintain global knowledge of the entire processed training set 311, enabling the model(s) to draw upon learned patterns and structures from the full training dataset. This global knowledge may be retained even when the model(s) are subsequently rapid fine-tuned using a smaller set of seed tracks, allowing the rapid fine-tuned model(s) to generate new content that is heavily influenced by the seed tracks while incorporating minor details from the broader training dataset.

In some embodiments, the generative AI model(s) of the audio data generator 315 may be rapid fine-tuned using the processed seed data 316. In some embodiments, the rapid fine-tuning may be accomplished through literal fine-tuning operations that modify the internal parameters of the generative AI model(s) of the audio data generator 315, through a context window approach that provides the processed seed data 316 as part of the input prompt, or through a combination of both approaches.

In some embodiments, when literal fine-tuning is employed, the processing logic may perform additional training iterations on the generative AI model(s) using the processed seed data 316 as the training input. Rapid fine tuning may include fine tuning the trained generative AI model(s) of audio data generator 315 by adjusting the parameter weights of the AI model(s) to use the processed seed data 316 more heavily in the generation of new audio data. This additional training may adjust the weights, biases, and/or other learnable parameters of the neural network architecture to prioritize patterns and characteristics present in the seed tracks 307. For example, the audio data generator 315 may provide weights to specific parameters of the AI model(s) that dictate how the AI model(s) interact the processed seed data 316. Rapid fine tuning instructs the generative AI model(s) of audio data generator 315 to generate a song composition (or a portion of a song composition) heavily influenced by the processed seed data 316 and to use the rest of the processed training dataset 311 to generate additional minor details. The literal fine-tuning approach may be advantageous when the system is configured to generate a large number of compositions (e.g., hundreds of tracks) from the same set of seed tracks, as the fine-tuned model can be reused for multiple generation requests without repeating the fine-tuning process.

In some embodiments, the rapid fine-tuning may be accomplished through a context window approach that provides the prompt and seed tracks as part of the input to the generative AI model, in contrast to the literal fine-tuning approach which can adjust the model's weights and parameters through additional training iterations. In some embodiments, when the context window approach is employed, the processing logic may format the processed seed data 316 together with a generation instruction into a combined input that is provided to the generative AI model(s) during inference. The context window may contain the compositional data, musical characteristics, and/or structural information from the seed tracks 307, effectively instructing the model to generate new content that follows the patterns established by the seed tracks. This approach may be advantageous when generating a single composition or a small number of compositions, as it avoids the computational overhead associated with modifying model parameters.

In some embodiments, the processing logic may select between literal fine-tuning and the context window approach based on one or more factors including the size of the context window supported by the generative AI model(s), the volume of data contained in the processed seed data 316, the number of compositions to be generated from the same seed tracks, and/or time constraints for generation. The processing logic may evaluate whether the context window has sufficient capacity to accommodate all relevant information from the processed seed data 316, and may default to literal fine-tuning when the data volume exceeds the context window capacity.

In some embodiments, the audio data generator 315 may receive as input a prompt that specifies desired characteristics of the musical content to be generated, such as mood, style, tempo, and/or other musical parameters. In some embodiments, the prompt may be the user request received at operation 301. In some embodiments, the processing logic may generate the prompt based on the user request by identifying musical variables from the user request and formulating the prompt to include or imply the identified musical variables. The musical variables may include song structure, genre of music, beats per minute (BPM), chord progression, key, musical style, melody, harmony, rhythm, timing, timbre, note density, and/or other musical characteristics. The processing logic may generate the prompt to include an instruction to generate new music based on the musical variables. In some embodiments, the processing logic may include the processed seed data 316 in the prompt, such that the prompt instructs the generative AI model(s) to generate new music based on the provided seed tracks and the specified musical variables.

In some embodiments, the audio data generator 315 may generate as output compositional data representing a new musical composition. The output may include musical notes, positions, timing, and/or instrument assignments for each part of the composition. In some embodiments, the compositional data may be similar to sheet music and may represent the structure and content of the new musical composition without being rendered into audio format.

In some embodiments, the audio data generator 315 may include multiple generative AI models, wherein each AI model is trained to generate a distinct section of a musical composition. For example, one AI model may be trained to generate song intros, another may be trained to generate verses, another may be trained to generate choruses, and additional models may be trained to generate bridges, outros, or other song sections. Each AI model may be rapid fine-tuned using the corresponding sections from the seed tracks 307. For instance, to generate an intro for a new composition, the AI model trained for intros may be rapid fine-tuned using only the intros from the seed tracks 307. The outputs from the multiple AI models may be combined according to song structure data to create a complete composition of a new musical content item.

In some embodiments, the audio creation governor 333 may implement one or more trained AI models to generate a new audio composition. In some embodiments, the audio creation governor 333 may receive audio structure data from the processed seed data 316. In some embodiments, the audio structure data may include information about the arrangement and sequence of sections in the seed tracks, such as intro, verse, chorus, bridge, and/or outro. In some embodiments, the audio creation governor 333 may receive compositional data from the audio data generator 315.

In some embodiments, the compositional data received from the audio data generator 315 may include a complete composition of a new content item. In some embodiments, the compositional data may include individual sections of a composition, wherein each section corresponds to a distinct portion of an audio content item, such as an intro, verse, chorus, bridge, or outro. When the audio data generator 315 includes multiple generative AI models, each trained to generate a specific section of a composition, the audio creation governor 333 may receive separate compositional outputs from each model.

In some embodiments, the audio creation governor 333 may combine the individual sections received from the audio data generator 315 according to the song structure data (e.g., based on processed seed data 316) to create a complete composition of a new content item. The audio creation governor 333 may arrange the sections in a sequence that matches or is derived from the audio structure identified in the processed seed data 316. For example, if the song structure data indicates a pattern of intro-verse-chorus-verse-chorus-outro, the audio creation governor 333 may assemble the individually generated sections in that order to produce the final composition.

In some embodiments, the audio creation governor 333 may process the seed tracks for additional musical data including key, beats per minute (BPM), chord progression, and/or song structure. From these values, the audio creation governor 333 may decide on the output structure and/or characteristics, and may coordinate the use of the rapid fine-tuned generative AI models to generate the appropriate sections. The audio creation governor 333 may ensure that the final composition has the desired song structure, instrumentation, and uses the correct model for the correct purpose.

In some embodiments, the audio creation component 320 may serve as a coordination framework that governs the interactions between the audio data generator 315 and the audio creation governor 333 to produce audio compositions. The audio creation component 320 may manage the flow of data between audio data generator 315 and the audio creation governor 333. For example, the audio creation component 320 can ensure that the compositional data generated by the audio data generator 315 is properly received and processed by the audio creation governor 333 according to the song structure data and musical parameters derived from the processed seed data 316.

In some embodiments, the audio creation component 320 may coordinate the generation process by directing the audio data generator 315 to produce compositional outputs based on the rapid fine-tuned generative AI model(s) and the provided prompts, while simultaneously instructing the audio creation governor 333 to combine, arrange, and structure the generated compositions according to the desired musical characteristics. The audio creation component 320 may facilitate communication between the audio data generator 315 and the audio creation governor 333 to ensure that the final composition maintains consistency with the seed tracks 307 and satisfies the requirements specified in the user request. In some embodiments, the audio creation component 320 may produce a complete song composition as output. In some embodiments, the audio creation component 320 may provide the song composition to an audio rendering and effects component 329.

In some embodiments, the processing logic may implement an instrument comparison engine 327 to identify the instruments used in the processed seed data 316. The instrument comparison engine 327 may correspond to the instrument comparison module 280 of FIG. 2. The instrument comparison engine 327 may receive the processed seed data 316 as input, which may include compositional data and musical characteristics extracted from the seed tracks 307. The instrument comparison engine 327 may analyze the processed seed data 316 to determine which musical instruments are present in the seed tracks and extract audio characteristics associated with those instruments.

In some embodiments, the instrument comparison engine 327 may generate a vector representation of the audio corresponding to the processed seed data 316. The instrument comparison engine 327 may use a pre-trained audio neural network, such as a pre-trained audio neural networks (PANNs) model, to generate vector representations of audio samples from the seed tracks. The vector representations may encode audio characteristics such as timbre, tone, and/or spectral features that distinguish different instruments. In some embodiments, the instrument comparison engine 327 may isolate portions of each seed track by instrument using stem separation techniques, such as demucs or similar stem-splitting libraries, to generate separate vector representations for each instrument type present in the seed tracks.

In some embodiments, the instrument comparison engine 327 may compare the vector representations with stored instrument data (e.g., instrument data 244 of FIG. 2) to identify which virtual instruments sound most similar to the instruments used in the processed seed data 316. The instrument data 244 may include a library of virtual instruments, each associated with its own vector representation generated using the same pre-trained audio neural network. The instrument comparison engine 327 may perform similarity comparisons between the vector representations from the seed tracks and the vector representations of the virtual instruments in instrument data 244. The instrument comparison engine 327 may calculate similarity scores or distance metrics, such as cosine similarity, to determine the closest matches. The instrument comparison engine 327 may identify a number of virtual instruments from the instrument data 244 that most closely resemble the instruments used in the seed tracks based on the comparison results.

The instrument comparison engine 327 may provide the identified instrument data as output to the audio rendering and effects component 329. The identified instrument data may specify which virtual instruments from the instrument data 244 should be used to render each part of the composition generated by the audio creation component 320. The audio rendering and effects component 329 may use the identified instrument data to assign appropriate virtual instruments to the corresponding tracks of the composition and generate the final audio output.

In some embodiments, the audio rendering and effects component 329 may render the audio composition received from the audio creation governor 333 into an audio content item. The audio rendering and effects component 329 may correspond to the audio rendering module 288 of FIG. 2. In some embodiments, the audio rendering and effects component 329 may receive compositional data from the audio creation governor 333, which may include musical notes, positions, timing, and/or instrument assignments for each part of the composition. The audio rendering and effects component 329 may also receive instrument selections from the instrument comparison engine 327, which identify the virtual instruments from instrument data 244 that most closely match the instruments used in the seed tracks 307.

In some embodiments, the audio rendering and effects component 329 may access the instrument data 244 to retrieve the selected virtual instruments. The audio rendering and effects component 329 may assign the identified virtual instruments to the corresponding parts of the composition based on the instrument assignments provided by the audio creation governor 333. The audio rendering and effects component 329 may generate digital audio output by processing the compositional data through the virtual instruments, thereby converting the compositional representation (similar to sheet music) into audible audio.

In some embodiments, the audio rendering and effects component 329 may merge the audio outputs from multiple virtual instruments to create a final audio file. The rendered audio may be stored in various digital audio formats including, but not limited to, WAV, MP3, FLAC, AAC, or other suitable audio formats. In some embodiments, the audio rendering and effects component 329 may coordinate with the audio creation governor 333 and the instrument comparison engine 327 to ensure that the rendered audio accurately reflects the compositional data and uses the appropriate virtual instruments. In some embodiments, the audio rendering and effects component 329 may apply audio processing techniques such as mixing, balancing, and effects to produce a polished final audio output that maintains the sonic characteristics of the seed tracks 307.

At operation 331, the processing logic may provide the final generated audio content item to a user device (e.g., client device 101 of FIG. 1). In some embodiments, the final generated audio content item may include the rendered audio output from the audio rendering and effects component 329, which includes the complete musical composition with virtual instruments applied to convert the compositional data into audible audio format. In some embodiments, the processing logic may transmit the final generated audio content item to the client device via network 131. In some embodiments, the audio generation interface 175 on the client device 101 may receive and present the final generated song to the user for playback, review, or further modification.

In some embodiments, the processing logic may provide additional data along with the final generated audio content item, including the compositional data (e.g., musical notes, positions, timing, and instrument assignments), metadata associated with the generated content item (e.g., the seed tracks used, the user request, identified instruments, and song structure information), and/or attribution data specifying the allocation of rights and royalties among the seed track rights holders, the user who provided the user request, and/or the organization maintaining the audio generation system 172. The user may access the final generated audio content item through the audio generation interface 175, which may provide playback controls, visualization elements, and/or options to modify the composition, change instruments, regenerate specific sections, and/or download the final generated audio content item in various digital audio formats.

In some embodiments, the processing logic may store the final generated audio content item in generated audio data 250 for subsequent retrieval, modification, playback, distribution, and/or licensing purposes. The final generated audio content item may be associated with the attribution data 248 to enable proper tracking of rights and royalties for the newly generated content item based on the seed tracks 307 that influenced its generation.

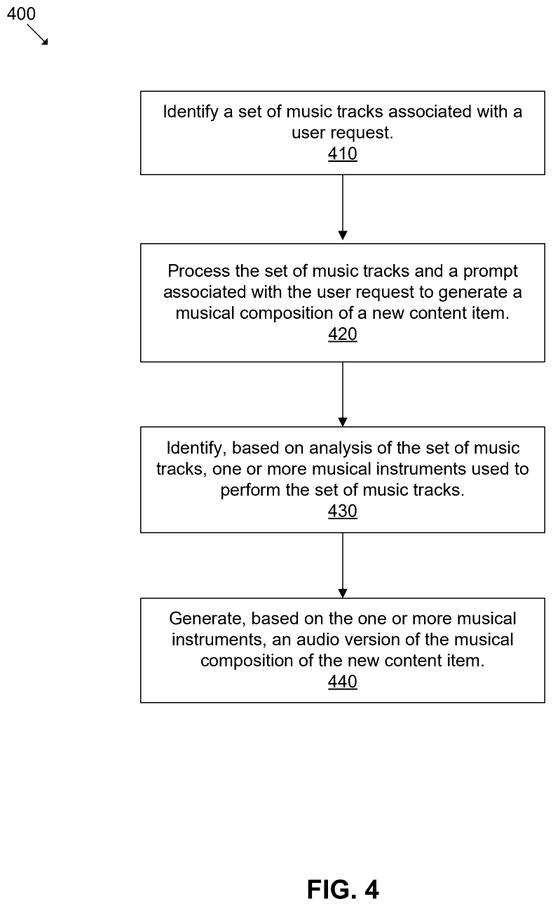

FIG. 4 is a flow diagram illustrating an example method 400 for generating a new audio content item using one or more rapid fine-tuned generative AI models, in accordance with some embodiments of the present disclosure. Method 400 may be performed by processing logic that comprises hardware (e.g., circuitry, dedicated logic, programmable logic, microcode, etc.), software (e.g., instructions run or executed on a processor), firmware, or a combination thereof. Method 400 may be performed, for example by one or more of computing device 101 and/or server computing device 150 of FIG. 1 in embodiments. Method 400 may be implemented, for example, by one or more audio generation system 172 of FIG. 1 executing on a processing device 502 of computing device 500 shown in FIG. 5. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 410, processing logic identifies a set of music tracks (e.g., seed tracks) associated with a user request. In some embodiments, identifying the set of music tracks associated with the user request may involve parsing the user request for relevant keyword information and/or song specifics. The processing logic may identify keywords related to musical characteristics such as genre, mood, style, tempo, instrumentation, key, and/or other musical attributes from the user request, in embodiments. The processing logic may translate the user request into musical elements by identifying keywords that correspond to tags or labels associated with tracks in a training dataset.

In some embodiments, identifying the set of music tracks may involve identifying, based on the user request, one or more values corresponding to musical variables. The musical variables may include at least one of song structure, melody, harmony, rhythm, timing, timbre, genre of music, note density, beats per minute, chord progression, key, and/or musical style. The processing logic may perform a search of a set of data to identify the set of tracks that have musical variables that correspond to the one or more values. The set of data may include a training dataset in which each track has been preprocessed and tagged with musical information including genre, key, moods, styles, beats per minute, chord progressions, note density, song structure, instrumentation, and/or other musical characteristics.

In some embodiments, the user request may include an indication of the set of music tracks. For example, the user request may specify particular songs by title and artist, may indicate a particular album whose tracks should be used as the set of tracks, and/or may provide audio files to be used as the set of tracks. In such embodiments, the processing logic may identify the set of music tracks directly from the user request without performing a search of the training dataset.

In some embodiments, the prompt may include an indication of at least one of a reference song, a collection of songs, or an artist. The indication of the reference song, collection of songs, and/or artist can be based on the information extracted from the user request. In such embodiments, identifying the set of tracks associated with the user request may involve identifying tracks from a training dataset that are representative of the at least one of the reference song, the collection of songs, or the artist. The processing logic may perform a sonic search of the training dataset based on the reference song, collection of songs, or artist to identify a number of tracks in the training dataset that sound similar to the indicated reference work. A sonic search may be described as an audio-based search that identifies audio clips, sound patterns, or songs using audio fingerprints or other audio similarity techniques. The processing logic may analyze audio characteristics such as timbre, rhythm, melody, harmony, instrumentation, and/or genre to identify representative tracks from the training dataset that match the sonic profile of the indicated reference song, collection of songs, and/or artist. The processing logic may store the representative tracks as the seed tracks for the generation process.

In some embodiments, the set of music tracks may include at least one of one or more audio tracks or composition data corresponding to one or more audio tracks. The composition data may include musical notes, positions, timing, key, chords, chord progressions, instrument choice, genre, note density, beats per minute, song structure, melody, harmony, rhythm, timing, and/or timbre extracted from the audio tracks.

In some embodiments, the processing logic may process the set of music tracks to identify a one or more parameters. The parameter(s) may include at least one of musical notes, note density, beats per minute, song structure, chord progression, key, style, or mood. The processing logic may tag each track of the set of tracks with the identified plurality of parameters to enable efficient retrieval and use of the musical information in subsequent operations.

At operation 420, processing logic processes the set of music tracks and a prompt associated with the user request to generate a musical composition of a new content item. In some embodiments, processing the set of music tracks and the prompt to generate the musical composition of the new content item includes providing, to a generative AI model, the set of tracks and a prompt associated with the user request. The generative AI model may be trained to generate a musical composition of a new content item. As used herein, a content item can refer to a musical work in any stage of creation or format, including a musical composition (e.g., compositional data representing musical notes, positions, timing, and instrument assignments), a rendered audio file (e.g., a recording of a synthetic performance of the composition), or both. A content item may include a complete musical work or a portion thereof, such as an intro, verse, chorus, bridge, and/or outro, in embodiments

In some embodiments, the prompt may be the user request itself, such that the user request is provided directly to the generative AI model. In some embodiments, the processing logic may generate the prompt based on the user request by identifying musical variables from the user request and formulating the prompt to include or imply the identified musical variables. The musical variables may include song structure, genre of music, beats per minute (BPM), chord progression, key, musical style, melody, harmony, rhythm, timing, timbre, and/or note density. For example, if the user request is “I want an upbeat workout song for running on the beach,” the processing logic may generate a prompt such as “generate an upbeat workout song with high energy, a tempo between 120-140 BPM, major key tonality, driving rhythm, and instrumentation suitable for a beach setting.”

In some embodiments, the generative AI model may have been trained on a training dataset that includes the set of music tracks and a plurality of additional music tracks. The training dataset may include thousands or millions of tracks that have been preprocessed and tagged with musical information. The generative AI model may learn patterns, structures, and/or relationships within musical data from the training dataset, including harmony, melody, rhythm, chord progressions, instrumentation, and/or song structure.

In some embodiments, the processing logic may perform a fine-tuning of the generative AI model using the set of tracks. The fine-tuning may adjust parameters of the generative AI model to heavily weight the set of tracks in the generation process while maintaining the model's global knowledge of the training dataset. The fine-tuning may involve modifying weights, biases, and/or other learnable parameters of the generative AI model to prioritize patterns and characteristics present in the set of tracks. The fine-tuned generative AI model may generate new content items that are heavily influenced by the set of tracks, such that the set of tracks constitutes a majority influence on the generated output.

In some embodiments, the set of tracks and the prompt may be provided to the generative AI model via a context window of the generative AI model. The context window may contain the set of tracks along with the prompt as a combined input to the generative AI model. The processing logic may format the set of tracks and the prompt into a single input that instructs the generative AI model to generate new music based on the provided set of tracks and the specified characteristics in the prompt. The context window approach may enable the generative AI model to generate content heavily influenced by the set of tracks without modifying the underlying model parameters.

In some embodiments, the generative AI model may include a plurality of AI models, wherein each AI model of the plurality of AI models is trained to generate a portion of a content item. For example, one AI model may be trained to generate an intro section, another AI model may be trained to generate a verse section, another AI model may be trained to generate a chorus section, and additional AI models may be trained to generate bridge sections, outro sections, or other portions of a musical composition. In some embodiments, the generative AI model may include an in-painting model configured to append, prepend, and/or replace a section of an existing composition by drawing upon the existing composition and the seed tracks to generate musically consistent sections. Each AI model may be fine-tuned using corresponding portions from the set of tracks. The outputs from the plurality of AI models may be combined according to song structure data to create a complete composition of the new content item.

In some embodiments, processing logic receives, from the generative AI model, the musical composition of the new content item. In some embodiments, the musical composition of the new content item may include compositional data representing musical notes, positions, timing, and/or instrument assignments for each part of the composition. In some embodiments, the musical compositional data may be similar to sheet music and may represent the structure and content of the new musical composition without being rendered into audio format. The musical compositional data may include information specifying which musical notes are to be played, when each note is to be played, the duration of each note, and which instrument is assigned to play each note or musical part.

In some embodiments, when the generative AI model includes a plurality of AI models, each trained to generate a portion of a content item, the processing logic may receive separate compositional outputs from each AI model. Each compositional output may correspond to a distinct section of the composition, such as an intro, verse, chorus, bridge, or outro. The processing logic may combine the separate compositional outputs according to song structure data to create a complete composition of the new content item. The song structure data may specify the arrangement and sequence of sections in the composition, and the processing logic may combine the individual sections in an order that matches or is derived from the song structure data.

In some embodiments, the musical composition of the new content item may include melody assignments, rhythm assignments, and/or percussion assignments that indicate which parts of the composition correspond to melodic elements, rhythmic elements, and/or percussive elements. In some embodiments, the musical composition may include instrument designations that specify which virtual instruments should be used to render each part of the musical composition into audio format. The musical compositional data may be stored for subsequent processing, including instrument identification and audio rendering operations.

At operation 430, processing logic identifies, based on an analysis of the set of music tracks, one or more musical instruments used to perform the set of music tracks. In some embodiments, the processing logic may analyze the set of music tracks to determine which musical instruments are present in each track of the set of music tracks. The processing logic may extract audio characteristics associated with the instruments used in the set of music tracks. The identification of the one or more musical instruments may enable the processing logic to select appropriate virtual instruments for rendering the musical composition of the new content item into audio format.

In some embodiments, the processing logic may generate a vector representation of audio corresponding to the set of music tracks. The processing logic may use a pre-trained audio neural network, such as a pre-trained audio neural networks (PANNs) model, to generate vector representations of audio samples from the set of music tracks. The vector representations may encode audio characteristics such as timbre, tone, and spectral features that distinguish different instruments. In some embodiments, the processing logic may isolate portions of each track in the set of music tracks by instrument using stem separation techniques, such as demucs or similar stem-splitting libraries, to generate separate vector representations for each instrument type present in the set of music tracks.

In some embodiments, the processing logic may compare the vector representation with a library of virtual instruments to identify which virtual instruments sound most similar to the instruments used in the set of music tracks. The library of virtual instruments may include multiple virtual instruments, each associated with its own vector representation generated using the same pre-trained audio neural network. The processing logic may perform similarity comparisons between the vector representations from the set of tracks and the vector representations of the virtual instruments in the library. The processing logic may calculate similarity scores or distance metrics, such as cosine similarity, to determine the closest matches. The processing logic may identify a number of virtual instruments from the library that most closely resemble the instruments used in the set of tracks based on the comparison results.

In some embodiments, the identified one or more musical instruments may include specific types or models of instruments, such as different piano models, different guitar types, various wind instruments, or percussion instruments. The identified instruments may be used in subsequent operations to render the composition of the new content item into audio format using the virtual instruments that match the sonic characteristics of the instruments in the set of tracks.

At operation 440, processing logic generates, based on the one or more musical instruments, an audio version of the musical composition of the new content item. In some embodiments, the processing logic may access a library of virtual instruments to retrieve the one or more musical instruments identified at operation 430. The processing logic may assign the identified virtual instruments to corresponding parts of the composition based on instrument assignments provided in the compositional data. The processing logic may generate digital audio output by processing the musical compositional data through the virtual instruments, thereby converting the musical compositional representation into audible audio format.

In some embodiments, the processing logic may render each part of the musical composition using the appropriate virtual instrument. For example, if the musical composition includes a piano part, a guitar part, and a percussion part, the processing logic may render the piano part using a virtual piano instrument, the guitar part using a virtual guitar instrument, and the percussion part using virtual percussion instruments. Each virtual instrument may generate audio samples corresponding to the musical notes, positions, and/or timing specified in the compositional data.

In some embodiments, the processing logic may merge the audio outputs from multiple virtual instruments to create a final audio file. The merging process may involve combining the separate audio tracks generated by each virtual instrument into a single audio file that represents the complete composition. The processing logic may apply audio processing techniques such as mixing, balancing, volume adjustment, and/or effects to produce a polished final audio output that maintains the sonic characteristics of the set of tracks.

In some embodiments, the processing logic may store the audio version of the musical composition in various digital audio formats including, but not limited to, WAV, MP3, FLAC, AAC, or other suitable audio formats. The processing logic may store the audio version along with metadata associated with the new content item, such as the set of tracks used in generation, the user request, the identified instruments, song structure information, and attribution data.

In some embodiments, the processing logic may provide the audio version of the musical composition to a user device (e.g., client device 101 of FIG. 1) for playback, review, or further modification. The user device may present the audio version through an audio generation interface that provides playback controls, visualization elements, and/or options to modify the composition, change instruments, regenerate specific sections, and/or download the audio version in various digital audio formats.

In some embodiments, the processing logic may determine, based on the set of music tracks, an attribution breakdown for the new content item. The attribution breakdown may reflect the collection rights for the newly generated content item. In some embodiments, the attribution breakdown may mirror the rights of the seed tracks. That is, the collection rights may be evenly divided among each of the seed tracks. In some embodiments, the attribution breakdown may include a certain percentage (e.g., 25%) attributed to the user who provided the user request, a certain percentage (e.g., 25%) attributed to the organization maintaining the generative AI model that generated the new content item (e.g., as an administrative fee), and the remainder (e.g., 50%) evenly divided among the seed tracks. The attribution breakdown may specify the allocation of rights and royalties among the seed track rights holders, the user who provided the user request, and the organization maintaining the audio generation system. In some embodiments, the attribution breakdown may include copyright ownership information, royalty percentage allocations, rights holder identification data, and/or licensing terms associated with each seed track. The processing logic may provide the attribution breakdown to the user device, along with the generated new content item.

In some embodiments, the prompt can include an indication of an audio content item and an indication of a target genre. The indication of the audio content item and/or the indication of the target genre can be based on the information extracted from the user request. In such embodiments, the set of music tracks corresponds to the target genre, wherein the audio version of the composition of the new content item corresponds to the target genre. That is, the processing logic may implement a genre transformation process that converts an audio content item corresponding to the indication of the audio content item from the user request from one genre to the target genre while preserving structural elements of the audio content item. The processing logic may receive or identify a particular track corresponding to the indication of the audio content item. The particular track may be a track of an actual performance or may be a synthetic track output by the generative AI model. The processing logic may receive or identify a request to change the genre of the particular track to a specified target genre.

In some embodiments, the processing logic may identify structural data of the particular track, including the song structure data, the chord progression, and/or the key. The structural data may be extracted through music information retrieval operations and/or may be retrieved from preprocessed metadata associated with the particular track. By identifying and preserving these structural elements, the processing logic may ensure that the transformed track maintains the fundamental musical framework of the original while adopting the stylistic characteristics of the target genre.

In some embodiments, the processing logic may identify the set of music tracks (e.g., seed tracks) from a training dataset that match the target genre. The identification process may involve searching the training dataset for tracks that are tagged or labeled with the target genre. The processing logic may store the identified seed tracks for use in the rapid fine-tuning process.

In some embodiments, the processing logic may perform rapid fine-tuning of the generative AI model using the identified seed tracks that match the target genre. The processing logic may provide the structural data of the particular track (such as the chord progression, key, and song structure) along with a prompt to the generative AI model. The generative AI model may generate a new composition that maintains the structural elements of the particular track while incorporating the stylistic characteristics of the target genre as learned from the seed tracks. The processing logic may also identify and select virtual instruments that are characteristic of the target genre, thereby ensuring that the genre-swapped track exhibits authentic sonic qualities associated with the target genre.

FIG. 5 illustrates a diagrammatic representation of a machine in the exemplary form of a computing device 500 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server machine in client-server network environment. The machine may be a personal computer (PC), a set-top box (STB), a server computing device, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computing device 500 may represent computing device 101 and/or server computing device 150, as shown in FIG. 1.

The computing device 500 includes a processing device (processor) 502, a main memory 504 (e.g., read-only memory (ROM), flash memory, dynamic random access memory (DRAM) such as synchronous DRAM (SDRAM)), a static memory 506 (e.g., flash memory, static random access memory (SRAM)), and a data storage device 518, which communicate with each other via a bus 530.

Processing device 502 represents one or more general-purpose processing devices such as a microprocessor, central processing unit, or the like. More particularly, the processing device 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 502 may also be one or more special-purpose processing devices such as an application specific integrated circuit (ASIC), a field programmable gate array (FPGA), a digital signal processor (DSP), network processor, or the like. The processing device 502 is configured to execute the audio generation system 172 for performing the operations and steps discussed herein.

The computing device 500 may further include a network interface device 508. The computing device 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 516 (e.g., a speaker).

The data storage device 518 may include a computer-readable medium 528 on which is stored one or more sets of instructions 522 (e.g., instructions of audio generation system 172) embodying any one or more of the methodologies or functions described herein. The instructions 522 may also reside, completely or at least partially, within the main memory 504 and/or within processing logic 526 of the processing device 502 during execution thereof by the computing device 500 (also referred to as a computer system), the main memory 504 and the processing device 502 also constituting computer-readable media. The instructions may further be transmitted or received over a network 520 via the network interface device 508.

While the computer-readable storage medium 528 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure.

In the above description, numerous details are set forth. It will be apparent, however, to one of ordinary skill in the art having the benefit of this disclosure, that embodiments of the disclosure may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining”, “identifying”, “comparing”, “selecting”, “generating” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the disclosure also relate to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct a more specialized apparatus to perform the required method steps. In addition, embodiments of the present disclosure are not described with reference to any particular programming language. It will be appreciated that a variety of programming languages may be used to implement the teachings of the disclosure as described herein.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
identifying a set of music tracks associated with a user request;
processing the set of music tracks and a prompt associated with the user request to generate a musical composition of a new content item;
identifying, based on analysis of the set of music tracks, one or more musical instruments used to perform the set of music tracks; and
generating, based on the one or more musical instruments, an audio version of the musical composition of the new content item.

2. The method of claim 1, wherein the set of music tracks are processed using a generative artificial intelligence (AI) model that has been trained on a training dataset comprising the set of music tracks and a plurality of additional music tracks.

3. The method of claim 1, wherein the set of music tracks are processed using a generative artificial intelligence (AI) model, the method further comprising:
performing, using the set of music tracks, a fine-tuning of the generative AI model.

4. The method of claim 1, wherein the set of music tracks are processed using a generative artificial intelligence (AI) model, and wherein the set of music tracks and the prompt are provided to the generative AI model via a context window of the generative AI model.

5. The method of claim 1, wherein the set of music tracks are processed using a plurality of artificial intelligence (AI) models, wherein each AI model of the plurality of AI models is trained to generate a portion of a content item.

6. The method of claim 1, further comprising:
determining, based on the set of music tracks, an attribution breakdown for the new content item.

7. The method of claim 1, wherein the set of music tracks comprises at least one of: one or more audio tracks, or composition data corresponding to one or more audio tracks.

8. The method of claim 1, further comprising:
processing the set of music tracks to identify a plurality of parameters comprising at least one of musical notes, note density, beats per minute, song structure, chord progression, key, style, or mood; and
tagging each track of the set of music tracks with the identified plurality of parameters.

9. The method of claim 1, wherein identifying the set of music tracks associated with the user request comprises:
identifying, based on the user request, one or more values corresponding to musical variables comprising at least one of song structure, melody, harmony, rhythm, timing, timbre, genre of music, note density, beats per minute, chord progression, key, or musical style; and
performing a search of a set of data to identify the set of music tracks that have musical variables that correspond to the one or more values.

10. The method of claim 9, wherein the prompt associated with the user request comprises at least one of the user request or the one or more values corresponding to the musical variables.

11. The method of claim 1, wherein the user request comprises an indication of the set of music tracks.

12. The method of claim 1, wherein the prompt comprises a first indication of an audio content item and a second indication of a target genre, wherein the set of tracks corresponds to the target genre, and wherein the audio version of the musical composition of the new content item corresponds to the target genre.

13. The method of claim 1, wherein the prompt comprises an indication of at least one of a reference song, a collection of songs, or an artist, and wherein identifying the set of tracks associated with the user request comprises identifying one or more tracks from a training dataset that are representative of the at least one of the reference song, the collection of songs, or the artist.

14. A system comprising:
a memory; and
a processing device coupled with the memory, wherein the processing device is configured to:
identify a set of music tracks associated with a user request, wherein one or more music tracks of the set of tracks are associated with instrument data indicating one or more musical instruments used to perform the one or more music tracks of the set of music tracks;
generate, based on the set of music tracks and a prompt associated with the user request, a musical composition of a new content item; and
generate, using the instrument data, an audio version of the musical composition of the new content item.

15. The system of claim 14, wherein to generate the musical composition of the new content item, the processing device is further configured to:
providing, to a generative artificial intelligence (AI) model, the set of music tracks and the prompt associated with the user request, wherein the generative AI model is trained to generate the musical composition of the new content item; and
receiving, from the generative AI model, the musical composition of the new content item.

16. The system of claim 15, wherein the processing device is further configured to:
perform, using the set of music tracks, a fine-tuning of the generative AI model.

17. The system of claim 15, wherein the set of music tracks and the prompt are provided to the generative AI model via a context window of the generative AI model.

18. The system of claim 15, wherein the generative AI model comprises a plurality of AI models, wherein each AI model of the plurality of AI models is trained to generate a portion of a content item.

19. The system of claim 15, wherein to identify the set of music tracks associated with the user request, the processing device is further configured to:
identify, based on the user request, one or more values corresponding to musical variables comprising at least one of song structure, melody, harmony, rhythm, timing, timbre, genre of music, note density, beats per minute, chord progression, key, or musical style; and
perform a search of a set of data to identify the set of music tracks that have musical variables that correspond to the one or more values.

20. A non-transitory computer readable medium comprising instructions that, when executed by a processing device, cause the processing device to perform operations comprising:
identifying a set of music tracks associated with a user request;
processing the set of music tracks and a prompt associated with the user request to generate a musical composition of a new content item;
identifying, based on analysis of the set of music tracks, one or more musical instruments used to perform the set of music tracks; and
generating, based on the one or more musical instruments, an audio version of the musical composition of the new content item.
